(19) United States
(12) Patent Application Publication
(10) Pub. No.: US 2017/0364966 A1
(43) Pub. Date: Dec. 21, 2017

(54) DETERMINATION DEVICE, DETERMINATION METHOD, AND NON-TRANSITORY COMPUTER-READABLE RECORDING MEDIUM

(71) Applicant: YAHOO JAPAN CORPORATION, Tokyo (JP)

(72) Inventor: Kenichi YAMADA, Tokyo (JP)

(73) Assignee: YAHOO JAPAN CORPORATION, Tokyo (JP)

(21) Appl. No.: 15/617,285

(22) Filed: Jun. 8, 2017

(30) Foreign Application Priority Data
Jun. 20, 2016 (JP) 2016-121792

(51) Int. Cl. G06Q 30/02

(52) U.S. Cl. CPC G06Q 30/0277; G06Q 30/0255; G06Q 30/0269

(57) ABSTRACT

A determination device according to the present application includes an acquisition unit, an estimation unit, and a determination unit. The acquisition unit acquires user information as information about a user. The estimation unit estimates a degree of contribution of the user to a predetermined service based on the user information acquired by the acquisition unit. The determination unit determines an aspect of providing information content to the user based on the degree of contribution estimated by the estimation unit. Accordingly, the determination device according to the present application improves cost effectiveness of the information content.

### CROSS-REFERENCE TO RELATED APPLICATION(S)

The present application claims priority to and incorporates by reference the entire contents of Japanese Patent Application No. 2016-121792 filed in Japan on Jun. 20, 2016.

### BACKGROUND OF THE INVENTION

### 1. Field of the Invention

The present invention relates to a determination device, a determination method, and a non-transitory computer readable recording medium having stored therein a determination program.

### 2. Description of the Related Art

In recent years, information has been actively provided via the Internet in accordance with rapidly growing use of the Internet. Examples of information provision include distribution of an Internet advertisement. For example, in a portable terminal such as a smartphone, an advertisement such as a banner is displayed together with content on a display screen for displaying the content by an application program (hereinafter, referred to as an “application”) and a browser. When a user clicks such an advertisement, for example, a download site of an application associated with the advertisement is displayed.

The user installs the application in the portable terminal via the advertisement as described above in some cases. As a technique related to installation of an application, there is known a technique of transmitting only information about an installed specific application to a server (for example, refer to Japanese Laid-open Patent Publication No. 2014-167688). There is also known a technique in which, when a selection operation is performed by the user in an off-line state, the selection operation is stored to cause predetermined processing to be performed when the state is switched to an on-line state (for example, refer to Japanese Laid-open Patent Publication No. 2013-257683).

However, in the related art described above, cost effectiveness of information content is not necessarily improved. It takes cost to distribute information content such as an advertisement, so that it is desirable for an advertiser that the advertisement is preferentially distributed to a user from which a reward corresponding to the cost can be obtained. The cost is preferably suppressed as much as possible for distribution to a user from which the reward corresponding to the cost is assumed not to be obtained. However, in the related art described above, although a result of the distributed advertisement (for example, a click rate) is measured, a reward is not measured, the reward brought to a service by the user to which the advertisement is distributed. Thus, it is difficult to appropriately adjust the cost taken for advertisement distribution and the reward corresponding to the cost.

### SUMMARY OF THE INVENTION

It is an object of the present invention to at least partially solve the problems in the conventional technology.

A determination device according to the present application includes an acquisition unit that acquires user information as information about a user, an estimation unit that estimates a degree of contribution of the user to a predetermined service based on the user information acquired by the acquisition unit, and a determination unit that determines an aspect of providing information content to the user based on the degree of contribution estimated by the estimation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of determination processing according to an embodiment;

FIG. 2 is a diagram for explaining an example of the determination processing according to the embodiment;

FIG. 3 is a diagram illustrating a configuration example of a determination processing system according to the embodiment;

FIG. 4 is a diagram illustrating a configuration example of the determination device according to the embodiment;

FIG. 5 is a diagram illustrating an example of an advertisement information storage unit according to the embodiment;

FIG. 6 is a diagram illustrating an example of an attribute table according to the embodiment;

FIG. 7 is a diagram illustrating an example of a device table according to the embodiment;

FIG. 8 is a diagram illustrating an example of an application table according to the embodiment;

FIG. 9 is a diagram illustrating an example of an application details table according to the embodiment;

FIG. 10 is a diagram illustrating an example of a classification table according to the embodiment;

FIG. 11 is a diagram illustrating an example of a cluster table according to the embodiment;

FIG. 12 is a diagram illustrating an example of a provision aspect table according to the embodiment;

FIG. 13 is a diagram illustrating a configuration example of a user terminal according to the embodiment;

FIG. 14 is a flowchart (1) illustrating a processing procedure according to the embodiment;

FIG. 15 is a flowchart (2) illustrating a processing procedure according to the embodiment; and

FIG. 16 is a hardware configuration diagram illustrating an example of a computer that implements a function of the determination device.

### DETAILED DESCRIPTION OF THE PREFERRED EMBODIMENTS

The following describes modes for implementing a determination device, a determination method, and a non-transitory computer readable recording medium having stored therein a determination program according to the present application (hereinafter, referred to as “embodiments”) in detail with reference to the drawings. The determination device, the determination method, and the non-transitory computer readable recording medium having stored therein the determination program according to the present application are not limited to the embodiments. The embodiments can be appropriately combined with each other without contradiction in processing content. In the embodiments, the same parts are denoted by the same reference numerals, and redundant description will not be repeated.

1. Example of Determination Processing

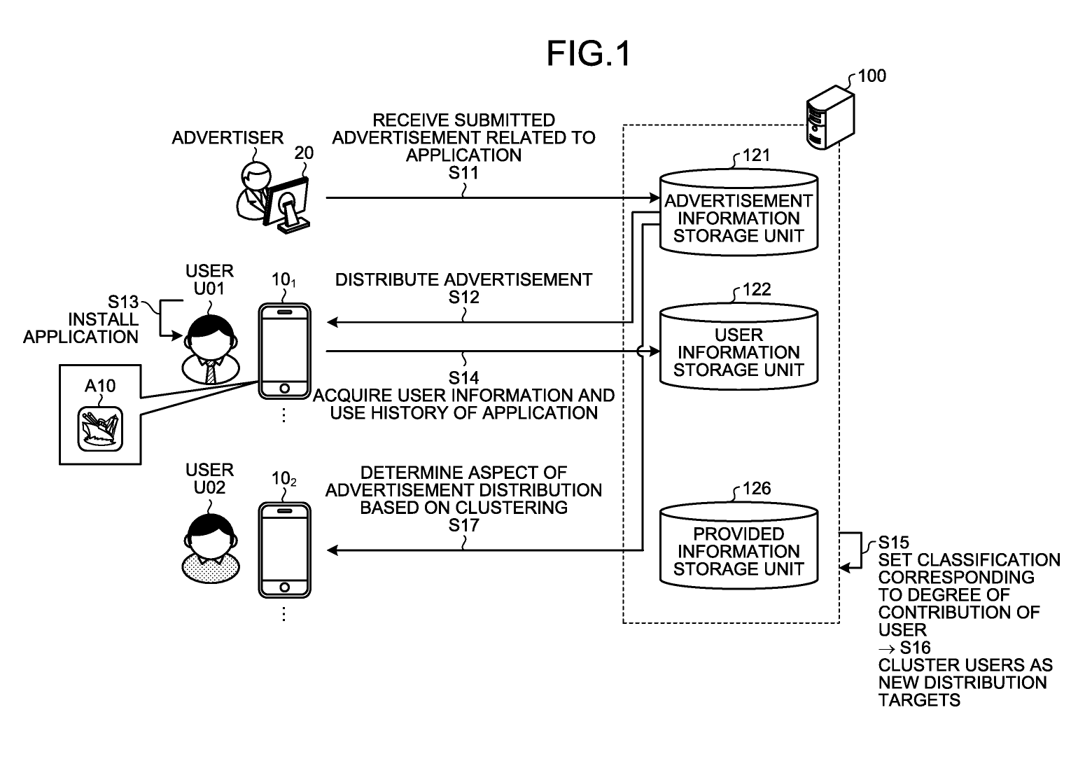

First, the following describes an example of determination processing according to an embodiment with reference to FIG. 1. FIG. 1 is a diagram illustrating an example of the determination processing according to the embodiment. FIG. 1 illustrates an example of processing in which a determination device 100 according to the present application determines an aspect for providing information content to a user. In the embodiment, as the information content, exemplified is an advertisement displayed on a Web page for advertising a predetermined application. That is, the aspect for providing the information content to the user means an aspect of advertisement distribution in the embodiment. In this case, a provider of the information content is an advertiser. In the embodiment, an advertisement provided by the advertiser is assumed to be an advertisement for prompting the user to install a predetermined application. The advertiser may be a provider not only of the advertisement but also of the application.

The determination device 100 illustrated in FIG. 1 is a server device that holds an advertisement submitted from an advertiser. When receiving a request of advertisement distribution from a terminal device operated by a user, the determination device 100 selects an advertisement to be distributed to the terminal device from among held advertisements. The determination device 100 then distributes the selected advertisement to the terminal device.

User terminals 10₁ and 10₂ illustrated in FIG. 1 are information processing terminals such as a smartphone. In the embodiment, the user terminal 10₁ is used by a user U01. The user terminal 10₂ is used by a user U02. The user terminals 10₁ and 10₂ request the determination device 100 to distribute an advertisement to be displayed in an advertisement display region when acquired content (for example, a Web page) includes the advertisement display region. The user terminals 10₁ and 10₂ display an acquired advertisement in the advertisement display region. In the following description, each of the user terminals 10₁ and 10₂ may be referred to as a “user terminal 10” when they are not required to be distinguished from each other.

An advertiser terminal 20 illustrated in FIG. 1 is a terminal device used by the advertiser. For example, the advertiser terminal 20 submits an advertisement to the determination device 100 in accordance with an operation by the advertiser. In the embodiment, an application as an advertising target is associated with the advertisement submitted by the advertiser. For example, when the user clicks an advertisement displayed on the user terminal 10, an application associated with the advertisement is installed in the user terminal 10, or screen display of the user terminal 10 is switched to a download page and the like of the application associated with the advertisement.

In the embodiment, when the user to which the advertisement is distributed installs the application, the determination device 100 estimates a degree of contribution indicating how much the user contributes to the application, and determines an aspect of advertisement distribution to the user. The degree of contribution is indicated by a predetermined reward to an application provider such as an amount of charge paid to the application provider by the user who uses the application, or improvement in an advertisement income of the application provider caused by frequent use of the application.

The aspect of advertisement distribution indicates an aspect of how to implement advertisement distribution such as an amount of advertising cost taken for causing the user to install the application, in other words, for acquiring the user as a customer, frequency of advertisement distribution to the user, and content of the advertisement distributed to the user.

For example, the determination device 100 determines the aspect of advertisement distribution so as to acquire a user estimated to have a high degree of contribution, that is, a user who brings a high reward to the application provider after the application is installed even with a large amount of advertising cost. Alternatively, the determination device 100 determines the aspect of advertisement distribution so as to suppress the cost taken for advertisement distribution to be a small amount for a user estimated to have a low degree of contribution. It may be said that the above processing is performed for adjusting cost such as expense or labor taken for advertisement distribution, and for adjusting cost effectiveness of the advertisement by the determination device 100. That is, the determination device 100 improves cost effectiveness of the advertisement by determining the aspect of advertisement distribution using a concept of the degree of contribution of the user.

The following describes an example of determination processing performed by the determination device 100 according to a procedure with reference to FIG. 1.

First, the determination device 100 receives an advertisement related to an application submitted from an advertiser via the advertiser terminal 20 (Step S11). The determination device 100 stores the received advertisement in an advertisement information storage unit 121. The determination device 100 specifies the application associated with the advertisement as an application from which the degree of contribution of the user is estimated. In the example of FIG. 1, the application as a processing target is assumed to be an application A10 that is a game application in a genre of a strategic type.

To estimate the degree of contribution of the user to the application A10, the determination device 100 distributes the advertisement related to the application A10 to the user U01 (Step S12). At Step S12, the determination device 100 has not performed determination processing according to the embodiment yet, so that the determination device 100 distributes the advertisement to the user U01 that is selected at random, for example. The determination device 100 may distribute the advertisement as a targeting advertisement corresponding to a user attribute and the like in accordance with a target setting designated by the advertiser. In the example of FIG. 1, the user terminal 10 to which the advertisement is distributed without the determination processing according to the embodiment is represented as the user terminal 10₁ for distinction.

In the example of FIG. 1, the user U01 is assumed to install the application A10 corresponding to the advertisement in accordance with the distributed advertisement (Step S13). At this point, the determination device 100 acquires user information that is information about the user U01 and the user terminal 10₁ from the user terminal 10₁ to which the advertisement associated with the application A10 is distributed. The determination device 100 acquires a use history of the application A10 from the user terminal 10₁ specified with the user information (Step S14). For example, the determination device 100 acquires, as the use history, the date and time when the application A10 is started, use frequency of the application A10, and an amount of charge paid by the user U01 in the application A10.

Although not illustrated in FIG. 1, the number of user terminals 10₁ to which the advertisement is distributed is assumed to be sufficient for performing estimation processing according to the embodiment. Details about the user information will be described later. The user information includes pieces of information indicating characteristics of the user such as attributes (a distinction of sex, age, a place of residence, and the like) of each user who uses the user terminal 10₁. The user information may include commuting time and the like of the user. This is because the number of users who use the user terminal 10 or the application during commuting time is relatively large, so that information of the commuting time may be an index value indicating a characteristic of the user who uses the application. In this way, by acquiring the user information, the determination device 100 can find a tendency as to a characteristic of the user U01 who uses the application A10.

The user information includes information about the user terminal 10. Examples of the information about the user terminal 10 include model number information added to the user terminal 10 during manufacturing, a manufacturer name extracted from the model number information, and a brand name of the user terminal 10 added by a manufacturer thereof. The information about the user terminal 10 may also include information such as a communication carrier of the user terminal 10 and resolution of a screen. For example, these pieces of information may be used for processing of estimating a tendency of installation of the application, or estimating attribute information of the user. For example, when the application to be processed by the determination device 100 is a game application, the user terminal 10 having higher throughput is installed with higher tendency, or the user terminal 10 having higher resolution of the screen is installed with higher tendency. In this case, the determination device 100 can perform estimation processing, clustering, and the like (described later) using the information about the user terminal 10 as an index value.

The determination device 100 may acquire information about an application that has been already installed in the user terminal 10 as the information about the user terminal 10. The application installed in the user terminal 10 may indicate interest of the user who handles the user terminal 10. The user tends to newly install an application in the same genre or category as that of the application that has been already installed. Thus, the determination device 100 can estimate information about interest of the user who handles the user terminal 10 or estimate a tendency of an application to be installed more easily in some cases based on the information about the application that has been already installed in the user terminal 10.

The determination device 100 stores the acquired user information in a user information storage unit 122. The determination device 100 continuously acquires a use history indicating that the application A10 is actually installed in the user terminal 10₁ to which the advertisement associated with the application A10 is distributed and how the application A10 is used.

The determination device 100 then classifies the user U01 based on the user information of the user U01 who has installed and used the application A10 and the use history of the application A10. For example, when the user information sufficient for performing classification processing is accumulated, the determination device 100 starts classification processing of the user U01. In the classification processing, first, the determination device 100 calculates the degree of contribution of the user U01 to the application A10 such as use frequency of the application A10 and an amount of charge in the application A10 based on the use history of the application A10. The determination device 100 then sets classification corresponding to the degree of contribution of the user U01 in the application A10 as a processing target (Step S15).

For example, the determination device 100 classifies the degree of contribution of the user U01 into five stages, and classifies the user U01 to correspond to each of the stages. Specifically, the determination device 100 classifies, into the stage 1, a user group of users U01 who have not only installed the application A10 but also started the application A10 thereafter within predetermined time (for example, within 24 hours). The determination device 100 classifies, into the stage 2, a user group of users U01 who have played the application A10 for predetermined time and users U01 who have experienced predetermined play (for example, a tutorial for explaining how to use the application A10) in the application A10. The determination device 100 classifies, into the stage 3, a user group of users U01 who have paid a charge to the application A10. The determination device 100 classifies the user group of the users U01 into the stage 4 or the stage 5 depending on an amount of charge.

At this point, the determination device 100 has acquired the user information of the user U01 belonging to each stage. Due to this, the determination device 100 can acquire relation between the degree of contribution to the application A10 and the user information in the user group of the users U01 who have installed the application A10. The determination device 100 appropriately stores information for classifying the user and information for distributing the advertisement in a provided information storage unit 126.

Subsequently, the determination device 100 clusters users as new distribution targets based on the classification of the user U01 who has already installed the application A10 (Step S16). For example, the determination device 100 acquires the user information from each of users U02 as a user group to which the advertisement related to the application A10 has not been distributed yet. The determination device 100 then classifies the user U02 into a cluster based on similarity between the user information obtained from the user U01 who has installed the application A10 and the user information of the user U02.

To classify the user U02 into a cluster, the determination device may use various known methods. For example, the determination device 100 performs hierarchical clustering on the user U02 based on the user information and the degree of contribution of the user U01. Specifically, the determination device 100 determines similarity between the user information of the user U02 and the user information of the user U01 belonging to a predetermined stage when the user U01 is classified. The determination device 100 groups users in the order of similarity in the user information to generate a grouping rule. Subsequently, the determination device 100 can apply the grouping rule to extract a user group of the users U02 similar to the user information of the users U01 belonging to the predetermined stage when the user U01 is classified. By repeating such processing, the determination device 100 can classify the user U02 into the cluster.

In this way, the determination device 100 can set a user group for the user U02, the user group similar to the user belonging to the stage set for the user U01. This means that the determination device 100 estimates the degree of contribution of the user U02 to the application A10 in the future based on the user information, the user U02 to which the advertisement has not been distributed yet. For example, the determination device 100 classifies the user U02 into five clusters. In this case, the user U02 classified into each cluster is assumed to be a user estimated to have a degree of contribution corresponding to each stage set for the user U01 in the future if the application A10 is installed.

The determination device 100 determines an aspect of advertisement distribution to the user U02 based on the clustering (Step S17). As described above, the determination device 100 performs clustering corresponding to the degree of contribution to the application A10. Accordingly, the determination device 100 increases proportion of cost taken for advertisement distribution for the cluster to which the user U02 estimated to have a higher degree of contribution belongs. That is, the determination device 100 determines that it is beneficial to cause the user U02 belonging to the cluster estimated to have the highest degree of contribution to install the application A10 even with high cost. Thus, the determination device 100 determines the aspect of advertisement distribution so as to give motivation for installing the application A10 to the user U02 even with high cost. For example, the determination device 100 determines the aspect of advertisement distribution so that a bid price is set to be relatively high in a bid of advertisement competition displayed on the user terminal 10₂ estimated to have a high degree of contribution, or distribution frequency is increased so that the advertisement for the application A10 is relatively frequently displayed on the user terminal 10₂.

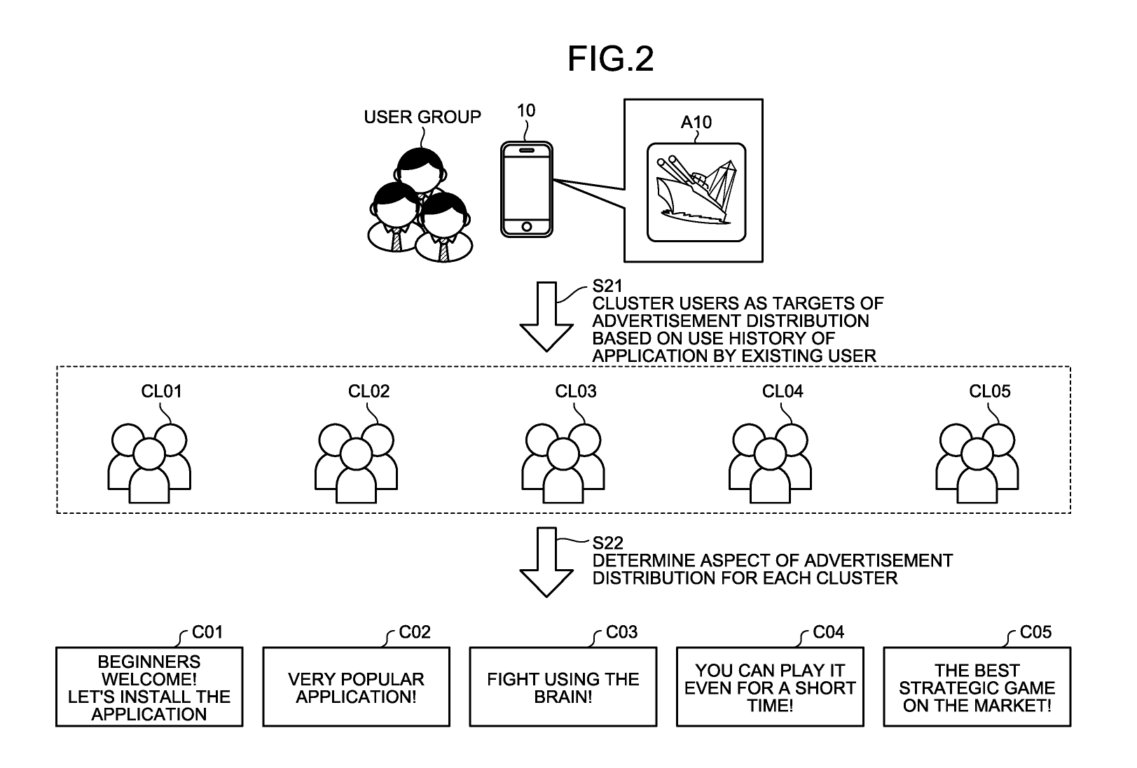

The determination device 100 can grasp a tendency of the user U02 belonging to each cluster by performing clustering based on the degree of contribution. In other words, the determination device 100 can acquire information about what type of information (a distinction of sex and age of the user, a terminal used by the user, a tendency of the application installed in the terminal, and the like) the user has, the user belonging to each cluster in the user group of the users U02 to which the advertisement is distributed. Based on such information, the determination device 100 may vary creativeness of the advertisement (in this case, it means content of the advertisement such as a sales message and an image displayed in the advertisement) even when the advertisement is used for advertising the same application A10. This point is described with reference to FIG. 2.

FIG. 2 is a diagram for explaining an example of the determination processing according to the embodiment. FIG. 2 illustrates a state in which the determination device 100 has clustered the user (in the example of FIG. 1, the user U02) as a target of advertisement distribution based on the use history of the application by an existing user (in the example of FIG. 1, the user U01) (Step S21).

As illustrated in FIG. 2, the determination device 100 classifies the users U02 into clusters CL01 to CL05. In the example of FIG. 2, the cluster CL01 is assumed to be a user group estimated to have the lowest degree of contribution, and the cluster CL05 is assumed to be a user group estimated to have the highest degree of contribution. In this case, through the clustering, a tendency for each cluster is assumed to be found in the user information of the users U02 classified into the clusters CL01 to CL05. Thus, the determination device 100 determines the aspect of advertisement distribution for each cluster to correspond to the user assumed to belong to each cluster (Step S22). For example, the determination device 100 may determine an aspect of distributing content of the advertisement to be distributed being varied for each cluster. In the example of FIGS. 1 and 2, the application A10 is assumed to be a game application in a strategic genre.

For example, the user U02 who has few opportunities for handling the user terminal 10 and the user U02 who is not really interested in games are assumed to belong to the cluster CL0T based on a low degree of contribution to the application A10 as the game application. In this case, the determination device 100 distributes an advertisement C01 including advertisement content for the user U02 who uses the game application for the first time such as “Beginners welcome! Let's install the application”.

On the other hand, the user U02 estimated to have a high degree of contribution to the application A10 is assumed to belong to the cluster CL04 and the cluster CL05, the user U02 being assumed to pay a large amount of charge to the application A10 or assumed to frequently use the application A10 in the future. In this case, the determination device 100 distributes an advertisement C04 including advertisement content directly explaining game content such as “You can play it even for a short time!”, and an advertisement C05 including advertisement content on the assumption that the user U02 has experience of using a game application in a similar genre such as “The best strategic game on the market!”. The determination device 100 may prepare an advertisement C06 and an advertisement C07 including different pieces of content (not illustrated) for the users U02 belonging to the cluster CL04 or the cluster CL05, and may distribute various advertisements. This is because the users U02 belonging to the cluster CL04 or the cluster CL05 are estimated to have a high degree of contribution, so that it is assumed to be beneficial to acquire the users U02 belonging to the cluster CL04 or the cluster CL05 even with high cost for preparing various advertisements.

The users U02 who frequently use the user terminal 10 in business but does not actively use the game application are assumed to belong to the cluster CL02 and the cluster CL03. In this case, the determination device 100 distributes an advertisement C02 including advertisement content suggesting a trend such as “Very popular application!”, and an advertisement C03 including advertisement content assumed to attract interest of a business people such as “Fight using the brain!”. In this way, the determination device 100 determines the aspect of advertisement distribution so that an advertisement assumed to have a high advertising effect is distributed to the user U02 belonging to each cluster. Every time the advertisement is distributed to the user U02, the determination device 100 may optimize the advertising effect through well-known learning processing and the like. That is, after distributing the advertisement that is assumed to be appropriate for the user U02 based on the user information, the determination device 100 may appropriately change the advertisement the advertising effect of which is not improved.

As described above with reference to FIGS. 1 and 2, the determination device 100 according to the embodiment acquires the user information as information about the user. The determination device 100 then estimates the degree of contribution of the user to a predetermined service (in the example of FIGS. 1 and 2, it means the application A10 itself or a service related to the game of the application A10) based on the acquired user information. The determination device 100 then determines an aspect of distributing the advertisement to the user based on the estimated degree of contribution.

In this way, the determination device 100 according to the embodiment can estimate the degree of contribution to the application of the user to which the advertisement is distributed, and determine the aspect of advertisement distribution based on the estimated information. Thus, the determination device 100 can determine the aspect such that cost of advertisement distribution is increased for the user from which an application provider is assumed to gain a higher profit by causing the user to install the application. Alternatively, the determination device 100 can determine the aspect such that cost of advertisement distribution is suppressed for the user from which a profit is hardly obtained even if the user is caused to install the application. That is, by estimating the degree of contribution to a result (in this case, installation of the application) of the advertisement to be distributed, the determination device 100 can adjust an aspect at a stage of advertisement distribution as a stage before the result is obtained to be an aspect corresponding to the degree of contribution. Accordingly, the determination device 100 can appropriately adjust the cost for advertisement distribution corresponding to the result achieved by the advertisement, so that cost effectiveness of advertisement distribution can be improved.

As described above, the determination device 100 estimates the degree of contribution of the user to the application as a processing target by using the user information that can be acquired from the user terminal 10 to determine the aspect of advertisement distribution. The following describes a configuration and the like of the determination device 100 that performs such processing and a determination processing system 1 including the determination device 100 in detail.

2. Configuration of Determination Processing System

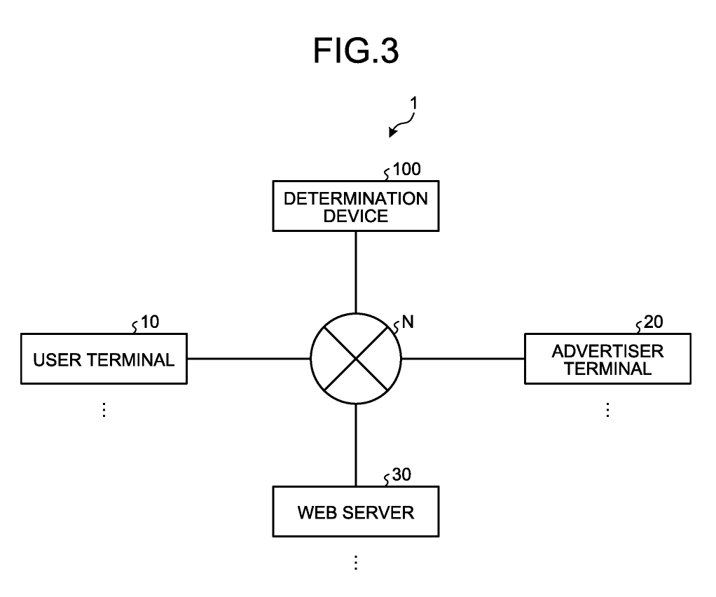

The following describes a configuration of the determination processing system 1 including the determination device 100 according to the embodiment with reference to FIG. 3. FIG. 3 is a diagram illustrating a configuration example of the determination processing system 1 according to the embodiment. As exemplified in FIG. 3, the determination processing system 1 according to the embodiment includes the user terminal 10, the advertiser terminal 20, a Web server 30, and the determination device 100. These various devices are connected in a wired or wireless manner to be able to communicate with each other via a network N (for example, the Internet). The determination processing system 1 illustrated in FIG. 3 may include a plurality of user terminals 10, a plurality of advertiser terminals 20, and a plurality of Web servers 30.

The user terminal 10 is, for example, an information processing device such as a smartphone, a desktop personal computer (PC), a notebook PC, a tablet device, a mobile phone, a personal digital assistant (PDA), and a wearable device. The user terminal 10 accesses the Web server 30 in accordance with an operation by the user to acquire a Web page from a Web site provided by the Web server 30. The user terminal 10 displays the acquired Web page on a display device (for example, a liquid crystal display). In the present application, the user may be identified with the user terminal 10. For example, “providing information content to the user” actually means “providing information content to the user terminal 10 used by the user” in some cases.

The advertiser terminal 20 is an information processing device used by the advertiser who requests the determination device 100 to distribute the advertisement. The advertiser terminal 20 submits the advertisement related to the application to the determination device 100 in accordance with an operation by the advertiser.

In some cases, the advertiser requests an agent to submit the advertisement instead of using the advertiser terminal 20 to submit the advertisement to the determination device 100. In this case, the agent submits the advertisement to the determination device 100. In the following description, an expression of “advertiser” is a concept including not only the advertiser but also the agent, and an expression of “advertiser terminal” is a concept including not only the advertiser terminal but also an agent device used by the agent.

The Web server 30 is a server device that provides various Web pages when being accessed by the user terminal 10. The Web server 30 provides, for example, various Web pages related to a news site, a weather forecast site, a shopping site, a finance (stock price) site, a route search site, a map providing site, a traveling site, a restaurant introduction site, and a weblog.

The Web page provided by the Web server 30 includes an advertisement space as a display region for displaying the advertisement. The Web page including the advertisement space includes an acquisition command for acquiring information content to be displayed in the advertisement space. For example, in a HyperText Markup Language (HTML) file and the like constituting the Web page, a URL and the like of the determination device 100 are described as the acquisition command. The user terminal 10 that has acquired the Web page accesses the URL described in the HTML file and the like to receive the advertisement distributed from the determination device 100.

The determination device 100 is a server device that determines an aspect of distributing the advertisement received from the advertiser terminal 20 to the user as a distribution destination. As described above, the determination device 100 estimates the degree of contribution of the user to a predetermined service based on the user information. The determination device 100 determines the aspect of advertisement distribution based on the estimated degree of contribution.

The determination device 100 identifies the user terminal 10, or acquires the user information of the user terminal 10. For example, the user information can be acquired by causing the information to be included in a cookie exchanged between a Web browser or a browser application of the user terminal 10 and the determination device 100. However, a method of acquiring the user information is not limited thereto. For example, a dedicated program may be set for the user terminal 10, and the user information may be transmitted from the dedicated program to the determination device 100. The determination device 100 may acquire the user information of the user terminal 10 from the Web server 30 accessed by the user terminal 10. The determination device 100 may acquire, from the application provider, information for estimating the degree of contribution such as an amount of charge paid by the user.

3. Configuration of Determination Device

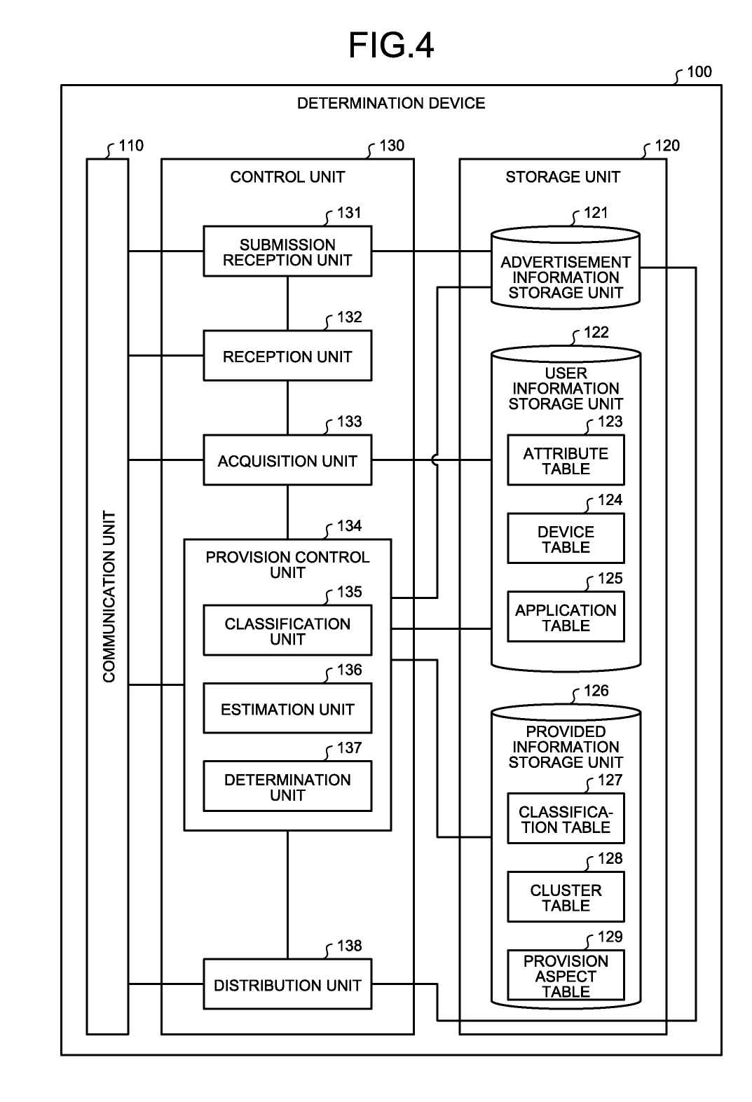

Next, the following describes the configuration of the determination device 100 according to the embodiment with reference to FIG. 4. FIG. 4 is a diagram illustrating a configuration example of the determination device 100 according to the embodiment. As illustrated in FIG. 4, the determination device 100 includes a communication unit 110, a storage unit 120, and a control unit 130. The determination device 100 may include an input unit (for example, a keyboard and a mouse) that receives various operations from an administrator and the like using the determination device 100, and a display unit (for example, a liquid crystal display) for displaying various pieces of information.

Regarding Communication Unit 110

The communication unit 110 is, for example, implemented by a network interface card (NIC) and the like. The communication unit 110 is connected to the network N in a wired or wireless manner, and transmits and receives information to/from the user terminal 10, the advertiser terminal 20, and the Web server 30 via the network N.

Regarding Storage Unit 120

The storage unit 120 is, for example, implemented by a semiconductor memory element such as a random access memory (RAM) and a flash memory, or a storage device such as a hard disk and an optical disc. The storage unit 120 includes the advertisement information storage unit 121, the user information storage unit 122, and the provided information storage unit 126.

Regarding Advertisement Information Storage Unit 121

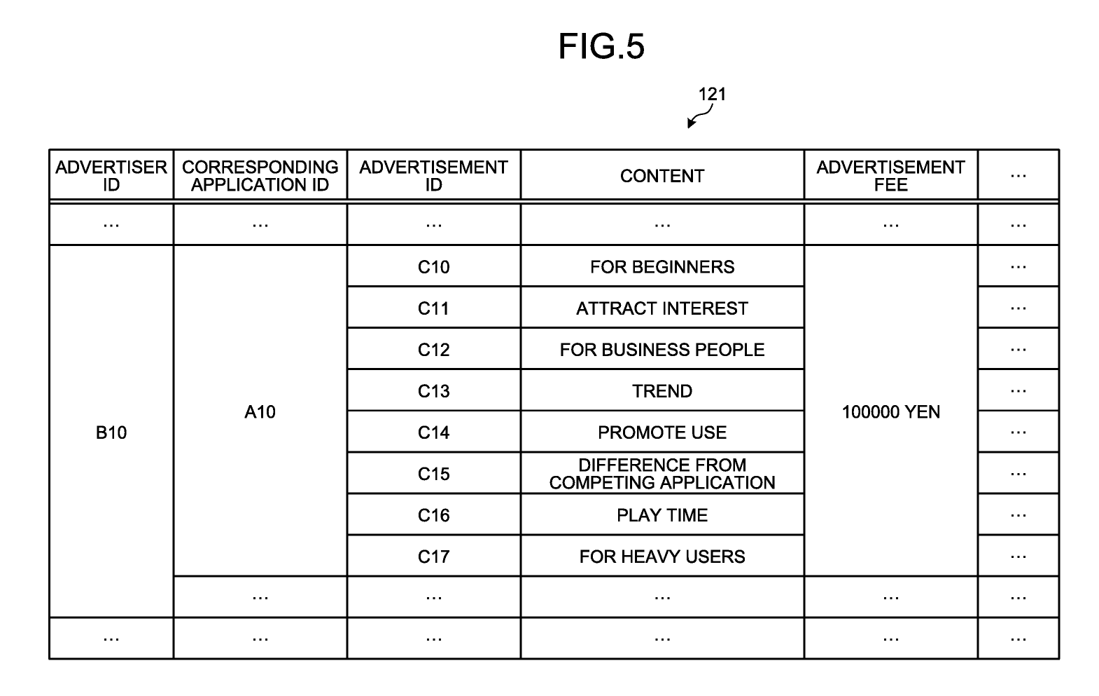

The advertisement information storage unit 121 stores therein information about the advertisement submitted from the advertiser terminal 20. In FIG. 5, illustrated is an example of the advertisement information storage unit 121 according to the embodiment. FIG. 5 is a diagram illustrating an example of the advertisement information storage unit 121 according to the embodiment. In the example illustrated in FIG. 5, the advertisement information storage unit 121 includes items such as an “advertiser ID”, a “corresponding application ID”, an “advertisement ID”, “content”, and an “advertisement fee”.

The “advertiser ID” indicates identification information for identifying the advertiser or the advertiser terminal 20. The “corresponding application ID” indicates identification information for identifying the application associated with the advertisement. The “advertisement ID” indicates identification information for identifying the advertisement submitted by the advertiser.

In the present application, the identification information as illustrated in FIG. 5 may be used as a reference numeral. For example, an advertiser identified with an advertiser ID “B10” may be expressed as an “advertiser B10”, an application identified with a (corresponding) application ID “A10” may be expressed as an “application A10”, and an advertisement identified with an advertisement ID “C10” may be expressed as an “advertisement C10”.

The “content” indicates advertisement content included in each advertisement. In the example of FIG. 5, the “content” describes only an advertising target and an outline of advertisement content such as “for beginners” and “attract interest”. The “content” may also store data actually constituting the advertisement such as text data constituting the advertisement and image data constituting the advertisement.

The “advertisement fee” is an advertisement fee charged to the determination device 100 by the advertiser B10 for advertisement distribution. For example, the advertisement fee is consumed every time when the advertisement is distributed, and distribution of the advertisement submitted by the advertiser B10 is ended at the time when the balance of the advertisement fee becomes zero.

That is, an example of data illustrated in FIG. 5 indicates that the advertiser B10 identified with the advertiser ID “B10” submits the advertisements “C10” to “C17” as advertisements corresponding to the application A10 identified with the application ID “A10”. For example, content of the advertisement C10 is indicated to be an advertisement “for beginners”. An advertisement fee charged by the advertiser B10 for the advertisement of the application A10 is indicated to be “100000 yen”.

Content data (text data, moving image content, and static image content) of the advertisement actually distributed to the user terminal 10 may be stored in a predetermined storage server that is provided separately from the determination device 100. In this case, the determination device 100 specifies an advertisement stored in an external storage server based on the advertisement ID stored in the advertisement information storage unit 121. The determination device 100 controls the storage server to distribute the specified advertisement to the user terminal 10.

The advertisement information storage unit 121 may store therein another piece of information related to the advertisement. For example, the advertisement information storage unit 121 may store therein a target condition of a distribution destination designated for each advertisement, a distribution number designated for each advertisement (designated impression number), and the like. The advertisement information storage unit 121 may store therein an index value indicating an advertising effect. For example, the advertisement information storage unit 121 may store therein index values such as a cost per install (CPI) and a click through rate (CTR) for each advertisement. The advertisement information storage unit 121 may store therein a distribution period and the like of the advertisements C10 to C17 designated by the advertiser B10.

Regarding User Information Storage Unit 122

The user information storage unit 122 stores therein information about the user and the user terminal 10 as distribution targets of the advertisement. As illustrated in FIG. 4, the user information storage unit 122 includes an attribute table 123, a device table 124, and an application table 125 as data tables that store therein the user information.

Regarding Attribute Table 123

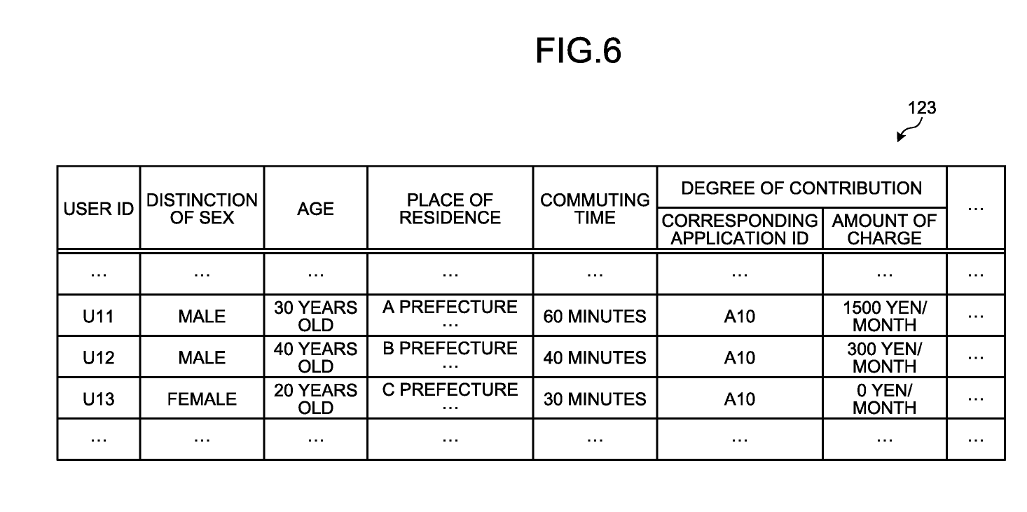

In FIG. 6, illustrated is an example of the attribute table 123 according to the embodiment. FIG. 6 is a diagram illustrating an example of the attribute table 123 according to the embodiment. The attribute table 123 mainly stores therein information about an attribute of the user who uses the user terminal 10. In the example illustrated in FIG. 6, the attribute table 123 includes items such as a “user ID”, a “distinction of sex”, “age”, a “place of residence”, “commuting time”, and a “degree of contribution”. The degree of contribution includes small items of a “corresponding application ID” and an “amount of charge”.

The “user ID” is identification information for identifying the user. The “distinction of sex” indicates a distinction of sex of the user who uses the user terminal 10. The “age” indicates age of the user who uses the user terminal 10. The “place of residence” indicates a place of residence of the user who uses the user terminal 10. As the “place of residence”, there may be stored a regional name (such as a Kanto region) indicating a certain range corresponding to the place of residence of the user, a name of the nearest station, and the like instead of a specific address.

The “commuting time” indicates average commuting time of the user. The commuting time may be acquired by the determination device 100 when reported by the user, or acquired when the determination device 100 estimates the commuting time based on a daily transition of positional information of the user terminal 10.

The “degree of contribution” indicates a degree of contribution of the user to a predetermined service. For example, the degree of contribution is measured with an amount of charge paid for a predetermined service, use time of the application, the number of times of starting the application, and the like. In FIG. 6, the “amount of charge” is illustrated as an example of the degree of contribution. The “amount of charge” indicates an amount of charge paid by the user for a corresponding application or a service provided by the application. FIG. 6 illustrates an example in which an average amount of charge per month is stored as the item of “amount of charge”, but an accumulated amount of charge and the like may be stored as the item of the amount of charge.

That is, in the example of data illustrated in FIG. 6, regarding a user U11 identified with a user ID “U11”, the distinction of sex is “male”, the age is “30 years old”, the place of residence is “A prefecture”, and the commuting time is “60 minutes”. Additionally, the user U11 has information about the amount of charge such as “1500 yen/month” for the application A10 as the degree of contribution.

The attribute information stored in the attribute table 123 is not necessarily accurate information. For example, the determination device 100 may store, in the attribute table 123, an “estimated distinction of sex”, “estimated age”, and the like estimated from a behavior history of the user on the network, installation information of the application, a characteristic of the user terminal 10 being used, and the like.

The attribute table 123 may appropriately store therein further attribute information of the user in addition to the information illustrated in FIG. 6. For example, depending on the application as a processing target, a predetermined tendency is found such that an unmarried user installs or plays the application with higher probability than a married user, and vice versa. That is, the attribute information about whether the user is unmarried or married can be a variable that affects easiness of installation or the degree of contribution. In this case, the determination device 100 may store the attribute information about whether the user is unmarried or married in the attribute table 123.

Regarding Device Table 124

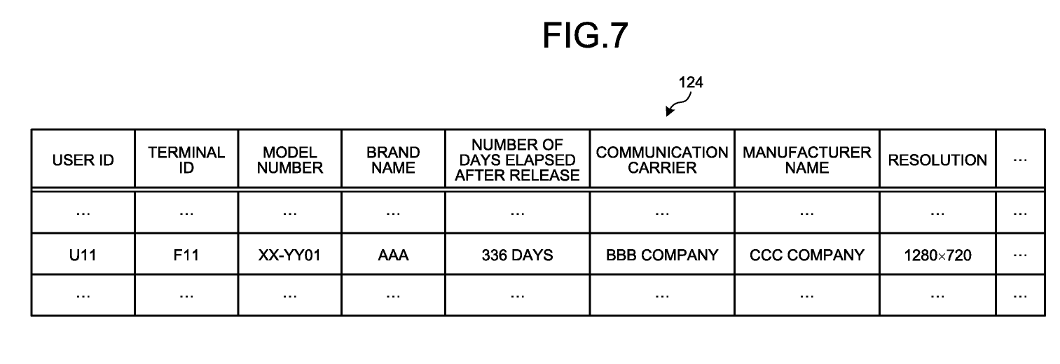

Subsequently, in FIG. 7, illustrated is an example of the device table 124 according to the embodiment. FIG. 7 is a diagram illustrating an example of the device table 124 according to the embodiment. The device table 124 mainly stores therein device information indicating information about a device itself, that is, the user terminal 10. In the example illustrated in FIG. 7, the device table 124 includes items such as a “user ID”, a “terminal ID”, a “model number”, a “brand name”, the “number of days elapsed after release”, a “communication carrier”, a “manufacturer name”, and “resolution”.

The “user ID” and the “terminal ID” correspond to the same items illustrated in FIG. 6. The “model number” indicates a model number of the user terminal 10. The “brand name” indicates a brand name given to the user terminal 10. The “number of days elapsed after release” indicates the number of days elapsed after the user terminal 10 is released. The “communication carrier” indicates a company name of a communication carrier providing a communication line of the user terminal 10. The “manufacturer name” indicates a name of a manufacturer of the user terminal 10. The “resolution” indicates resolution of a screen of the user terminal 10.

That is, in the example of data illustrated in FIG. 7, regarding the user terminal 10 that is identified with the terminal ID “F11” and used by the user U11, the model number is “XX-YY01”, and the brand name is “AAA”. Regarding the user terminal 10 identified with the terminal ID “F11”, “336 days” have been elapsed after its release, the communication carrier is “BBB company”, the manufacturer is “CCC company”, and the resolution is “1280×720”.

The device table 124 may appropriately store therein further information of the user terminal 10 in addition to the information illustrated in FIG. 7. For example, a tendency of the user as a target may be set in the user terminal 10. For example, information indicating a characteristic of each terminal may be set in the user terminal 10 by a manufacturer, for example, the information indicating that the user terminal is for beginners, the user terminal is used for business, or the user terminal has high-resolution for a game and a moving image. Such information may be one of characteristics indicating the tendency of the user. In this case, the determination device 100 may store such characteristic information in the device table 124.

Regarding Application Table 125

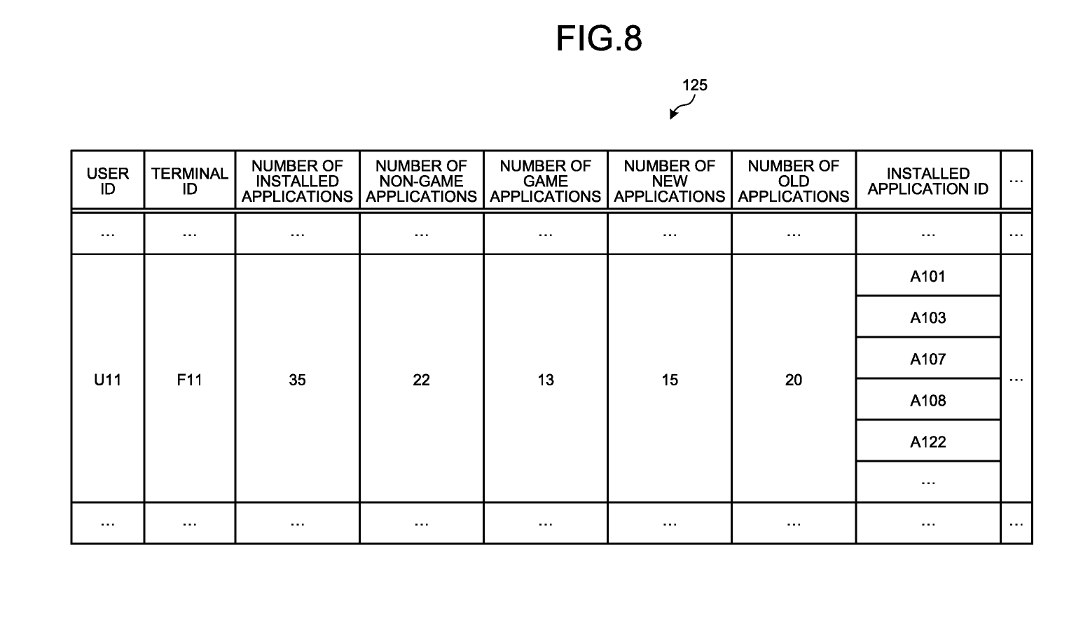

Subsequently, in FIG. 8, illustrated is an example of the application table 125 according to the embodiment. FIG. 8 is a diagram illustrating an example of the application table 125 according to the embodiment. The application table 125 mainly stores therein information about the application installed in the user terminal 10. In the example illustrated in FIG. 8, the application table 125 includes items such as a “user ID”, a “terminal ID”, the “number of installed applications”, the “number of non-game applications”, the “number of game applications”, the “number of new applications”, the “number of old applications”, and an “installed application ID”.

The “user ID” and the “terminal ID” correspond to the same items illustrated in FIG. 7. The “number of installed applications” indicates a total number of applications installed in the user terminal 10. The “number of non-game applications” indicates the number of applications other than the game application among the installed applications. The “number of game applications” indicates the number of game applications among the installed applications. The “number of new applications” indicates the number of applications that are started to be provided relatively recently (for example, within a half year, or within 1 year) among the installed applications. The “number of old applications” indicates the number of applications other than the new applications among the installed applications. The “installed application ID” indicates identification information of each application installed in the user terminal 10.

That is, in the example of data illustrated in FIG. 8, “35” applications are installed in the user terminal 10 that is identified with the terminal ID “F11” and used by the user U11 identified with the user ID “U11”. Among the applications installed in the user terminal 10 identified with the terminal ID “F11”, the number of non-game applications is “22”, and the number of game applications is “13”. Among the applications installed in the user terminal 10 identified with the terminal ID “F11”, the number of new applications is “15”, and the number of old applications is “20”. The applications installed in the user terminal 10 identified with the terminal ID “F11” are applications identified with identification information such as “A101”, “A103”, “A107”, “A108”, and “A122”.

The application table 125 may further include a data table indicating specific content of the application. For example, the application table 125 may include an application details table 125A in addition to the information illustrated in FIG. 8.

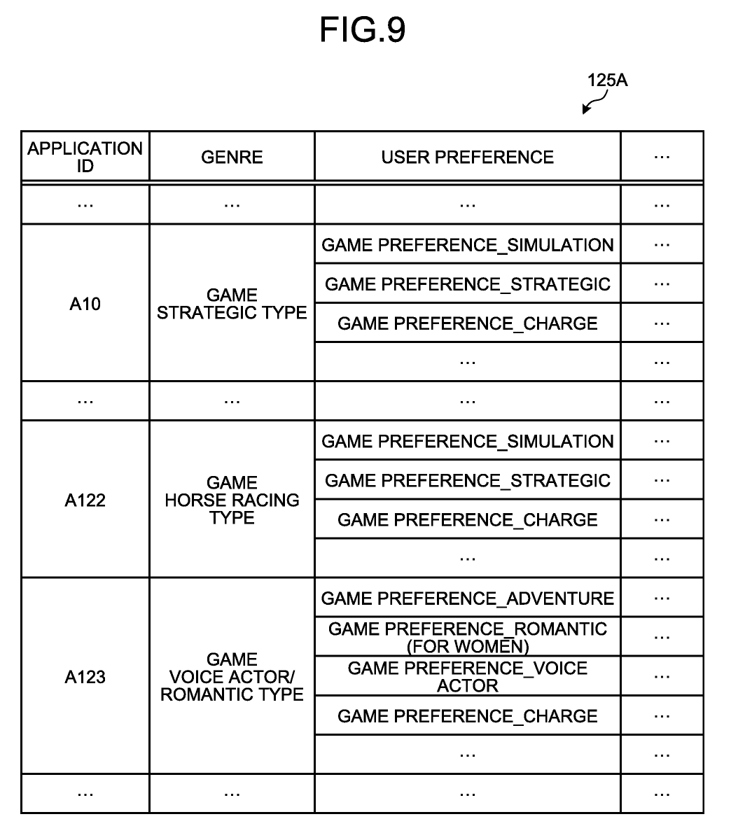

In FIG. 9, illustrated is an example of the application details table 125A according to the embodiment. FIG. 9 is a diagram illustrating an example of the application details table 125A according to the embodiment. As illustrated in FIG. 9, the application details table 125A includes items such as an “application ID”, a “genre”, and a “user preference”.

The “application ID” indicates identification information for identifying the application. The “genre” indicates a genre of the application. For example, the genre indicates classification of the application such as for a game or for communication. The genre may include information indicating a genre of a game such as a strategic type or a horse racing type among games. The “user preference” indicates preference information estimated to attract interest of the user who has installed the application. For example, the user preference is preference information set in the application in advance such as whether the user prefers the game, and what type of game genre is preferred by the user. The determination device 100 can use, for example, not only the distinction of sex and the age of the user but also information about the user preference as information for classifying the user. For example, the determination device 100 can perform estimation processing for estimating that the user who tends to frequently install an application having a characteristic similar to that of the application A10 as a processing target tends to install the application A10. For example, by using an element such as “game preference strategic” as a variable (determination element) in the estimation processing described below, the determination device 100 can estimate the user who tends to install a similar application.

In the example of data illustrated in FIG. 9, the application A10 identified with the application ID “A10” is an application belonging to genres of “game” and “strategic type”, and pieces of characteristic information such as “game preference simulation”, “game preference strategic”, and “game preference charge” are set as the user preference. An application A122 identified with an application ID “A122” is an application belonging to genres of “game” and “horse racing type”, and pieces of characteristic information such as “game preference simulation”, “game preference strategic”, and “game preference charge” are set as the user preference. In this case, the application A10 and the application A122 have common characteristic information, so that the application A10 and the application A122 are determined to tend to be installed or played by users having similar preferences.

On the other hand, an application A123 identified with an application ID “A123” is an application belonging to genres of “game” and “voice actor/romantic type”, and pieces of characteristic information such as “game preference_adventure”, “game preference romantic (for women)”, “game preference_voice actor”, and “game preference_charge” are set as the user preference. In this case, although the application A10 and the application A123 are both the game applications, the number of common pieces of characteristic information is relatively small, so that the application A10 and the application A123 are not determined to tend to be installed or played by users having similar preferences in some cases.

Regarding Provided Information Storage Unit 126

The provided information storage unit 126 stores therein information about an aspect of providing information content (in the embodiment, an aspect of advertisement distribution). As illustrated in FIG. 4, the provided information storage unit 126 includes a classification table 127, a cluster table 128, and a provision aspect table 129 as data tables for storing therein information about determination processing.

Regarding Classification Table 127

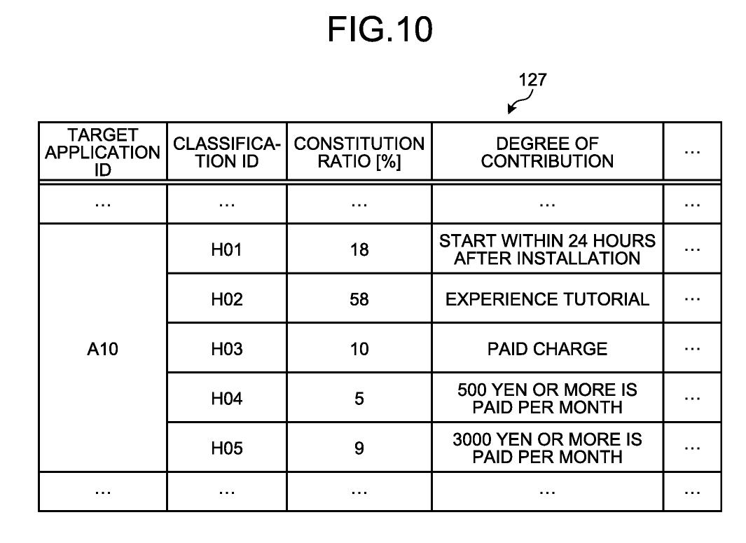

The classification table 127 stores therein classification information obtained by classifying the user based on the degree of contribution of the user to a predetermined service. In FIG. 10, illustrated is an example of the classification table 127 according to the embodiment. FIG. 10 is a diagram illustrating an example of the classification table 127 according to the embodiment. In the example illustrated in FIG. 10, the classification table 127 includes items such as a “target application ID”, a “classification ID”, a “constitution ratio (%)”, and a “degree of contribution”.

The “target application ID” indicates identification information of the application corresponding to a service as a target of classification processing. The “classification ID” is identification information obtained by classifying the user. Classification identified with the classification ID corresponds to, for example, the stage of the user U01 described above with reference to FIG. 1.

The “constitution ratio (%)” indicates a constitution ratio indicating that how many users belong to a certain one of classified user groups. The “degree of contribution” indicates the degree of contribution of the user to a predetermined service. The degree of contribution is, for example, different between applications. When the processing target is a game application such as the application A10, as illustrated in FIG. 10, the degree of contribution is represented by an amount of charge, for example.

That is, in the example of data illustrated in FIG. 10, classification identified with the identification information such as “H01”, “H02”, “H03”, “H04”, and “H05” is present for the application A10 identified with the target application ID “A10”. The classification H01 includes users the constitution ratio of which is “18%” in the user group as a processing target, and the degree of contribution of the users is “starting the application within 24 hours after installation”.

Regarding Cluster Table 128

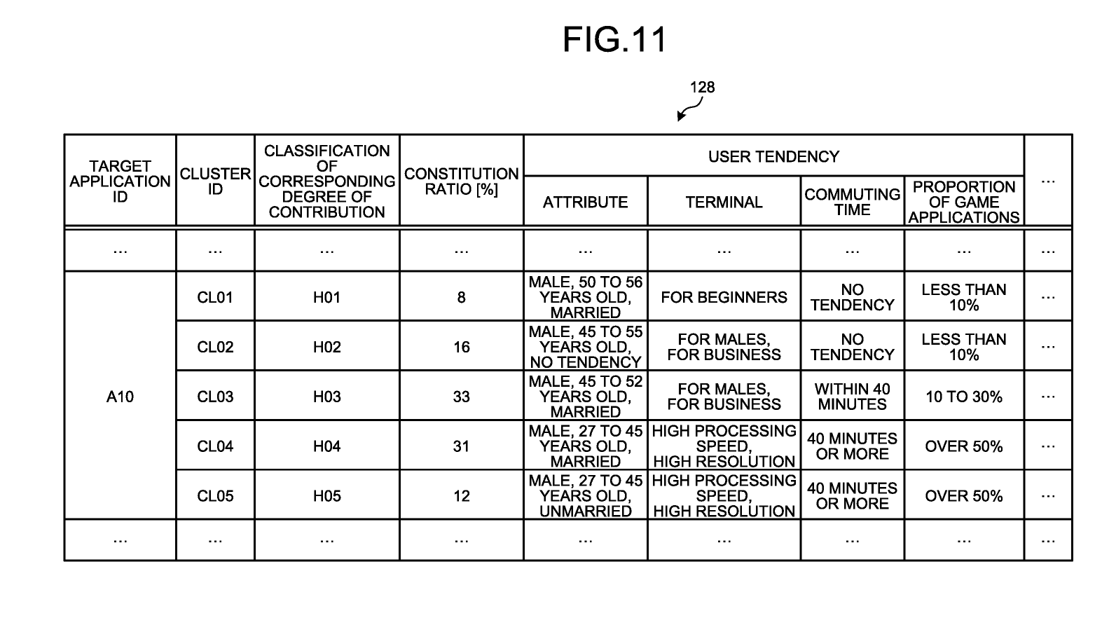

The cluster table 128 stores therein information about clustering of the user as a new distribution target. In FIG. 11, illustrated is an example of the cluster table 128 according to the embodiment. FIG. 11 is a diagram illustrating an example of the cluster table 128 according to the embodiment. As illustrated in FIG. 11, the cluster table 128 includes items such as a “target application ID”, a “cluster ID”, a “classification of corresponding degree of contribution”, a “constitution ratio (%)”, and a “user tendency”. The “user tendency” includes small items such as an “attribute”, a “terminal”, “commuting time”, and a “game application ratio”.

The “target application ID” indicates identification information of the application corresponding to a service as a target of clustering. The “cluster ID” indicates identification information of the cluster obtained by clustering the user.

The “classification of corresponding degree of contribution” indicates information that, when the user belonging to a cluster installs the application, how much the degree of contribution is estimated to be given to the service corresponding to the application. In the embodiment, the “classification of corresponding degree of contribution” corresponds to the classification illustrated in FIG. 10. That is, when the “classification of corresponding degree of contribution” is “H01”, the user belonging to the cluster is estimated to have a degree of contribution of “starting the application within 24 hours after installation”.

The “constitution ratio (%)” indicates a constitution ratio indicating that how many users belong to a certain cluster in the user group as a target of clustering.

The “user tendency” indicates a tendency of the user belonging to the cluster. For example, the user tendency is derived based on a distribution ratio and the like of information in the user information of users constituting each cluster. In other words, the user tendency indicates information to which the highest ratio of users correspond among the users constituting the cluster.

The “attribute” indicates a tendency of an attribute of the user belonging to the cluster. The “terminal” indicates a tendency of a terminal used by the user belonging to the cluster. The “commuting time” indicates a tendency of commuting time of the user belonging to the cluster. The “game application ratio” indicates a proportion of the game application in applications that have been already installed by the user belonging to the cluster. FIG. 11 illustrates only four pieces of user information as elements constituting the “user tendency”, but this is merely an example. The pieces of user information constituting the “user tendency” may be various pieces of information stored in the user information storage unit 122, for example.

That is, in the example of data illustrated in FIG. 11, assuming that the application A10 identified with the target application ID “A10” is a processing target, the users are clustered into five clusters identified with “CL01”, “CL02”, “CL03”, “CL04”, and “CL05” based on the degree of contribution made by the user when the application A10 is installed. The degree of contribution of the user belonging to the cluster CL01 is estimated to be substantially the same as the degree of contribution of the user classified into “H01”, and users belonging to the cluster CL01 are “8%” of all users to which the advertisement is about to be distributed. The users belonging to the cluster CL01 mainly have attributes of “male, 50 to 56 years old, married”, the terminal to be used is “for beginners”, there is no tendency of commuting time, and the proportion of installed game applications tends to be “less than 10%”. On the other hand, the users belonging to the cluster CL05 mainly have attributes of “male, 27 to 45 years old, unmarried”, the terminal to be used has “high processing speed, high resolution”, the commuting time is “40 minutes or more”, and the proportion of installed game applications tends to “over 50%”.

Regarding Provision Aspect Table 129

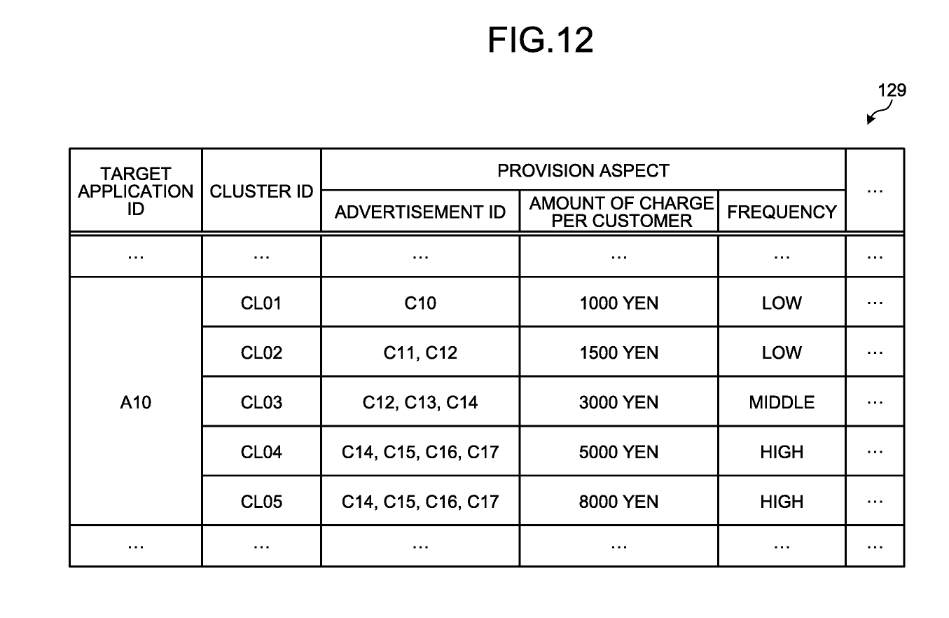

The provision aspect table 129 stores therein information about provision of information content (an aspect of advertisement distribution). In FIG. 12, illustrated is an example of the provision aspect table 129 according to the embodiment. FIG. 12 is a diagram illustrating an example of the provision aspect table 129 according to the embodiment. As illustrated in FIG. 12, the provision aspect table 129 includes items such as a “target application ID”, a “cluster ID”, and a “provision aspect”. The “provision aspect” includes small items such as an “advertisement ID”, an “amount of charge per customer”, and “frequency”.

The “target application ID” indicates identification information of the application corresponding to the advertisement to be distributed. The “cluster ID” indicates identification information of the cluster obtained by clustering the user to which the advertisement is distributed.

The “provision aspect” indicates an aspect of advertisement distribution for each cluster. The “advertisement ID” indicates identification information of the advertisement to be distributed. The “amount of charge per customer” indicates an amount of charge of the advertisement fee that is allowed for acquiring one user. In the embodiment, the “amount of charge per customer” indicates the advertisement fee to be paid until one user installs the application A10. The “frequency” indicates frequency of distributing the advertisement to the user. In the example of FIG. 12, the frequency is represented as relative information such as low, middle, and high. However, for example, the frequency may be represented by a specific numerical value such as the number of times of participation in a bid of the advertisement within predetermined time.

That is, in the example of data illustrated in FIG. 12, assuming that the application A10 identified with the target application ID “A10” is a processing target, the advertisement is distributed to five clusters identified with “CL01”, “CL02”, “CL03”, “CL04”, and “CL05” in different provision aspects. For example, advertisement distribution is performed in an aspect such that the advertisement C10 identified with the advertisement ID “C10” is mainly distributed as the advertisement related to the application A10 to the user belonging to the cluster CL01, the advertisement fee to be paid until one user installs the application is “1000 yen” at a maximum, and frequency of the advertisement is “low”. Alternatively, advertisement distribution is performed in an aspect such that any one of the advertisements identified with the advertisement IDs “C14”, “C15”, “C16”, and “C17” is distributed as the advertisement related to the application A10 to the user belonging to the cluster CL05 depending on a situation, the advertisement fee to be paid until one user installs the application is “8000 yen” at a maximum, and frequency of the advertisement is “high”.

Regarding Control Unit 130

The control unit 130 is a controller. For example, the control unit 130 is implemented when various programs (corresponding to an example of the determination program) stored in a storage device inside the determination device 100 are executed by a central processing unit (CPU), a micro processing unit (MPU), and the like using a RAM as a working area. The control unit 130 is a controller, and implemented by an integrated circuit such as an application specific integrated circuit (ASIC) and a field programmable gate array (FPGA), for example.

As illustrated in FIG. 4, the control unit 130 includes a submission reception unit 131, a reception unit 132, an acquisition unit 133, a provision control unit 134, a classification unit 135, an estimation unit 136, a determination unit 137, and a distribution unit 138, and implements or executes a function or operation of information processing described below. The internal structure of the control unit 130 is not limited to the structure illustrated in FIG. 4, and may be any other structure for performing information processing described later. A connection relation among processing units included in the control unit 130 is not limited to the connection relation illustrated in FIG. 4, and may be another connection relation.

Regarding Submission Reception Unit 131

The submission reception unit 131 receives the advertisement submitted from the advertiser terminal 20. The submission reception unit 131 associates the advertiser ID for identifying the advertiser as a submitting source, the advertisement ID for identifying the advertisement, and the application ID for identifying the application corresponding to the advertisement with each other to be stored in the advertisement information storage unit 121. The submission reception unit 131 may receive the advertisement fee for advertisement distribution, a condition for a user as a distribution destination, and the like from the advertiser. The submission reception unit 131 may receive, from the advertiser, a targeting setting such as designation of user information as a distribution destination of the advertisement.

Regarding Reception Unit 132

The reception unit 132 receives a distribution request of the advertisement. Specifically, the reception unit 132 receives a request that is sent from the user terminal 10 displaying a Web page and is related to distribution of the advertisement displayed in the advertisement space included in the Web page. The reception unit 132 may receive the request of advertisement distribution transmitted from the user terminal 10, and receive identification information for identifying the user terminal 10.

Regarding Acquisition Unit 133

The acquisition unit 133 acquires various pieces of information. For example, the acquisition unit 133 acquires user information as information about the user terminal 10 that receives the advertisement and the user who uses the user terminal 10.

Specifically, the acquisition unit 133 acquires attribute information of the user who uses the user terminal 10 as the user information. For example, the acquisition unit 133 acquires the distinction of sex, the age, the place of residence, the commuting time, and the like of the user as the user information.

The acquisition unit 133 acquires, as the user information, information about the user terminal 10 that is used by the user and in which the application for using a predetermined service can be installed. For example, the acquisition unit 133 acquires, as the information about the user terminal 10, a model number, a brand name, a time elapsed from its release, a name of communication carrier, a manufacturer name, resolution, and the like set for the user terminal 10.

The acquisition unit 133 may acquire information about the application installed in the user terminal 10. For example, the acquisition unit 133 acquires information such as a total number of applications installed in the user terminal 10, the number of game applications installed in the user terminal 10, a proportion of the number of game applications to the total number of applications installed in the user terminal 10, and a genre of each game application installed in the user terminal 10.

The acquisition unit 133 may acquire result information indicating whether the user terminal 10 that has received the advertisement exhibits a predetermined behavior related to the advertisement. Specifically, the acquisition unit 133 acquires result information indicating whether the user terminal 10 installs the application as a target of determination processing by the classification unit 135 described later.

The acquisition unit 133 acquires a use history of the application from the user terminal 10 when the application is installed. For example, the acquisition unit 133 acquires, as the use history, the date and time when the application is installed, the date and time when the application is started after installation, use time of the application, use frequency of the application, an amount of charge on the application or a service related to the application, and the like. The acquisition unit 133 may acquire the amount of charge and the like on the service from the advertiser terminal 20, the Web server 30, and the like.

The acquisition unit 133 stores the acquired information in a predetermined storage unit. For example, when acquiring the user information, the acquisition unit 133 stores the acquired information in the user information storage unit 122. Alternatively, the acquisition unit 133 may send the acquired information to a processing unit such as the provision control unit 134.

The acquisition unit 133 may use various known methods to implement a method for acquiring information about the advertisement such as whether the advertisement is clicked, and whether the application corresponding to the advertisement is installed. For example, the acquisition unit 133 may use a notification function implemented by a web beacon and the like to acquire the information about the advertisement.

Regarding Provision Control Unit 134

The provision control unit 134 controls processing related to provision of information content. In the embodiment, the provision control unit 134 controls processing related to advertisement distribution as provision of information content. As illustrated in FIG. 4, in the provision control unit 134, the classification unit 135, the estimation unit 136, and the determination unit 137 cooperate with each other to implement the processing.

Regarding Classification Unit 135

The classification unit 135 classifies the user based on the degree of contribution of the user to a predetermined service. For example, the classification unit 135 refers to the use history of the user related to a predetermined application, and calculates the degree of contribution of the user to the application or a service related to the application. The classification unit 135 classifies the user into a predetermined stage corresponding to the degree of contribution.

For example, the application as a processing target is the application A10, the classification unit 135 specifies the user who has installed the application A10 based on the information acquired by the acquisition unit 133. The classification unit 135 then calculates the degree of contribution to the application A10 based on the use history of the application A10 in the user terminal 10 in which the application A10 is installed. For example, as illustrated in FIGS. 1 and 2, the classification unit 135 classifies the user who has installed the application A10 in accordance with the amount of charge on the application A10, the use frequency of the application A10, and the like.

Regarding Estimation Unit 136

The estimation unit 136 estimates the degree of contribution of the user to a predetermined service based on the user information acquired by the acquisition unit 133. Specifically, the estimation unit 136 estimates the degree of contribution of the user to which information content is newly provided (in the example of FIG. 1, the user U02) based on a relation between the user information acquired by the acquisition unit 133 and the use history of the predetermined service in a user group that used the predetermined service in the past (in the example of FIG. 1, the user U01).

For example, the estimation unit 136 clusters the user group to which the advertisement is newly distributed using a method of hierarchical clustering based on similarity between the user information about the user group classified by the classification unit 135 and the user information about the user group to which the advertisement is newly distributed. For example, the estimation unit 136 determines similarity between the user information about the user group belonging to a predetermined stage classified by the classification unit 135 and the user group to which the advertisement is newly distributed to cluster a user group similar to the user group belonging to the predetermined stage classified by the classification unit 135 from the user group to which the advertisement is newly distributed.

Through the above processing, the estimation unit 136 can acquire information about which user belonging to any of the stages classified by the classification unit 135 the user to which the advertisement is newly distributed is similar to. Accordingly, the estimation unit 136 can acquire information about how much the degree of contribution to the predetermined service is made by the user to which the advertisement is newly distributed in the future, so that the estimation unit 136 can estimate the degree of contribution of the user to which the advertisement is newly distributed. For example, the estimation unit 136 estimates the degree of contribution of the user to the predetermined service based on at least one of a behavior of the user for the predetermined service, frequency of using the predetermined service by the user, and time during which the user uses the predetermined service. Examples of the behavior of the user for the predetermined service include various behaviors such as a behavior of paying a charge by the user in using the predetermined service, an amount of charge, a behavior of submitting a message to the service, a behavior of visiting a Web site related to the service, and installing not only the application associated with the advertisement but also an application provided by the same provider as that of the application associated with the advertisement. In addition to the above examples, in a case in which an incentive is assumed to be generated for the service when the user selects (for example, clicks) the advertisement, the estimation unit 136 may use the incentive as an element for estimating the degree of contribution. That is, the estimation unit 136 may estimate the degree of contribution based on various rewards given by the user for the predetermined service.

The estimation unit 136 may perform clustering using an optional piece of user information. For example, the estimation unit 136 performs clustering using the attribute information such as the age and the distinction of sex of the user among the pieces of user information. In this case, a user who has already installed the application A10 and has age and a distinction of sex similar to those of the user having a relatively high degree of contribution to the application A10 is clustered to be classified into a cluster including a user assumed to have substantially the same degree of contribution as the user having a relatively high degree of contribution to the application A10.

Alternatively, the estimation unit 136 performs clustering using the device information of the user terminal 10 among the pieces of user information. In this case, a user who has already installed the application A10 and uses a terminal similar to that of the user having a relatively high degree of contribution to the application A10 is clustered to be classified into the cluster including a user assumed to have substantially the same degree of contribution as the user having a relatively high degree of contribution to the application A10. That is, the estimation unit 136 estimates the degree of contribution of the user to which information content is newly provided based on a relation between the information about the user terminal 10 acquired by the acquisition unit 133 and the use history of the application A10 in the user group that used the application A10 in the past.

When using the device information of the user terminal 10, the estimation unit 136 can cluster a user who uses a terminal having a performance similar to that of a terminal used by the user who has already installed the application A10, and can also perform clustering using attribute information of the user estimated from the device information.

That is, the device information of the user terminal 10 may include an element from which the attribute information of the user can be estimated. For example, the brand name “AAA” of the user terminal 10 as illustrated in FIG. 7 is assumed to be a brand that is generally preferred by males and has a sophisticated image. In this case, the user who uses the user terminal 10 having the brand name “AAA” is assumed to be a person who is male and prefers the sophisticated image. In this way, the determination device 100 can use the brand name of the user terminal 10 as an element for characterizing a person such as the user U01. The determination device 100 uses “the number of days elapsed from its release” as an element for characterizing such as whether the user who uses the user terminal 10 is a person who prefers a relatively new thing. The determination device 100 uses the “communication carrier” as an element for characterizing such as whether the user who uses the user terminal 10 desires a stable communication line, or desires a low price. The determination device 100 uses the “resolution” as an element for characterizing such as whether the user prefers a relatively large screen.

In this way, by using not only the age and the distinction of sex but also the device information and the like of the user terminal 10, the estimation unit 136 can estimate not only similarity in the attribute information itself of the user but also similarity in a behavior or personality itself of the user. Accordingly, for example, the estimation unit 136 can accurately estimate users assumed to exhibit a similar behavior for the application A10. This means that the estimation unit 136 can accurately estimate a user similar to the user who already has a high degree of contribution to the application A10, that is, the estimation unit 136 can accurately estimate the degree of contribution.

The estimation unit 136 may perform clustering by combining optional pieces of the user information. Accordingly, the estimation unit 136 can extract users having information similar to that of the user having a high degree of contribution to the application A10 as a user group belonging to the same cluster. In other words, the estimation unit 136 can accurately extract users for whom high cost can be allowed for advertisement distribution.

Regarding Determination Unit 137

The determination unit 137 determines an aspect of providing information content to the user based on the degree of contribution estimated by the estimation unit 136. In the embodiment, the determination unit 137 determines an aspect of distributing the advertisement to the user.

Specifically, the determination unit 137 determines the aspect of distributing the advertisement for each cluster into which the user as a new provision destination of information content is classified based on a relation between the user information and the degree of contribution estimated by the estimation unit 136. For example, when the acquisition unit 133 acquires the attribute information of the user, the determination unit 137 determines the aspect of distributing the advertisement for each cluster that is classified based on a relation between at least one of the distinction of sex, the age, the place of residence, and the commuting time of the user and the degree of contribution estimated by the estimation unit 136.

As the aspect of distributing the advertisement, the determination unit 137 determines at least one of cost taken for distributing the advertisement to a predetermined user, frequency of distributing the advertisement, and content of the advertisement to be distributed. The determination unit 137 determines the aspect of distributing the advertisement so that, as the degree of contribution of the user estimated by the estimation unit 136 is higher, at least one of the cost taken for distributing the advertisement, the frequency of distributing the advertisement, and frequency of change in the content of the advertisement becomes higher. For example, the determination unit 137 determines the aspect of distribution so that, for the user belonging to the cluster that is estimated to have a relatively high degree of contribution by the estimation unit 136, the advertisement fee is set to be high to cause the user to install the application A10 even with relatively high cost, or various advertisements are distributed to the user.

When the acquisition unit 133 acquires a new piece of information after the aspect of advertisement distribution is determined for each cluster, the determination unit 137 may update the aspect of advertisement distribution as needed. In other words, such updating means that the determination unit 137 performs predetermined learning processing such as learning which aspect is the most effective, the aspect of how the advertisement distribution is performed on what type of users.

Regarding Distribution Unit 138

The distribution unit 138 distributes the advertisement in response to an advertisement distribution request received by the reception unit 132. When the aspect of advertisement distribution is determined by the determination unit 137, the distribution unit 138 distributes the advertisement in accordance with the determination.

As described above, the advertisement data itself actually distributed to the user terminal 10 is not necessarily stored in the advertisement information storage unit 121 related to the determination device 100. For example, the distribution unit 138 may transmit a control command to a predetermined external storage server to cause the advertisement to be distributed to the user terminal 10.

4. Configuration of User Terminal

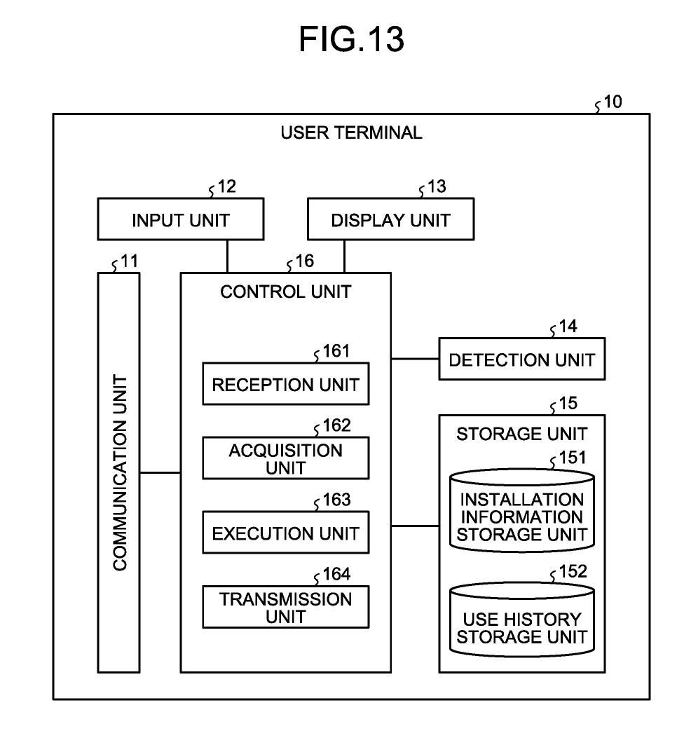

Next, the following describes the configuration of the user terminal 10 according to the embodiment with reference to FIG. 13. FIG. 13 is a diagram illustrating a configuration example of the user terminal 10 according to the embodiment. As illustrated in FIG. 13, the user terminal 10 includes a communication unit 11, an input unit 12, a display unit 13, a detection unit 14, a storage unit 15, and a control unit 16. A connection relation among processing units included in the user terminal 10 is not limited to the connection relation illustrated in FIG. 13, and another connection relation may be employed.

The communication unit 11 is connected to the network N in a wired or wireless manner, and transmits and receives information to/from the Web server 30 or the determination device 100. For example, the communication unit 11 may be implemented by a NIC and the like.

The input unit 12 is an input device that receives various operations from the user. For example, the input unit 12 is implemented by an operation key and the like included in the user terminal 10. The input unit 12 may include an imaging device (a camera and the like) for photographing an image, and a sound collector (a microphone and the like) for collecting sound.

The display unit 13 is a display device for displaying various pieces of information. For example, the display unit 13 is implemented by a liquid crystal display and the like. When a touch panel is used for the user terminal 10, part of the input unit 12 is integrated with the display unit 13.

The detection unit 14 detects various operations on the user terminal 10 and environment information and the like around the user terminal 10. For example, the detection unit 14 is implemented by a sensor or an antenna that detects various pieces of information. Specifically, the detection unit 14 detects a communication status related to an appliance connected to the user terminal 10, an illuminance and noise around the user terminal 10, a physical movement of the user terminal 10, positional information of the user terminal 10, and the like.

The storage unit 15 stores therein various pieces of information. The storage unit 15 is, for example, implemented by a semiconductor memory element such as a RAM and a flash memory, or a storage device such as a hard disk and an optical disc. In the example illustrated in FIG. 13, the storage unit 15 includes an installation information storage unit 151 and a use history storage unit 152. The installation information storage unit 151 stores, for example, information of the application installed in the user terminal 10. The use history storage unit 152 stores, for example, a use history related to the application used by the user.

For example, the control unit 16 is implemented when various programs stored in a storage device inside the user terminal 10 are executed by a CPU, an MPU, and the like using a RAM as a working area. The control unit 16 is, for example, implemented by an integrated circuit such as an ASIC and an FPGA.

The control unit 16 controls various pieces of processing performed in the user terminal 10. As illustrated in FIG. 13, the control unit 16 includes a reception unit 161, an acquisition unit 162, an execution unit 163, and a transmission unit 164, and implements or executes a function or operation of information processing described below.

The reception unit 161 receives various pieces of information. For example, the reception unit 161 receives information transmitted from the Web server 30 or the determination device 100. Specifically, the reception unit 161 receives the advertisement that is distributed in response to a request of advertisement distribution. The reception unit 161 receives various pieces of information detected by the detection unit 14.

The acquisition unit 162 acquires various pieces of information and data. For example, the acquisition unit 162 accesses the Web server 30 to acquire a Web page desired by the user to view. The acquisition unit 162 acquires advertisement data and the like received by the reception unit 161. The acquisition unit 162 acquires data used for installing the application via a download site and the like of the application.

The execution unit 163 executes various pieces of processing in the user terminal 10. For example, the execution unit 163 executes processing of installing the application. When the execution unit 163 installs the application, information about the installation is stored in the installation information storage unit 151.

The transmission unit 164 transmits various pieces of information. For example, when the Web page acquired by the acquisition unit 162 includes an advertisement space, the transmission unit 164 transmits a request of advertisement distribution to the determination device 100. The transmission unit 164 refers to the storage unit 15 and the like, and transmits the user information of the user terminal 10 to the determination device 100. The transmission unit 164 refers to the storage unit 15 and the like, and transmits the use history of the application in the user terminal 10 to the determination device 100.

5. Processing Procedure

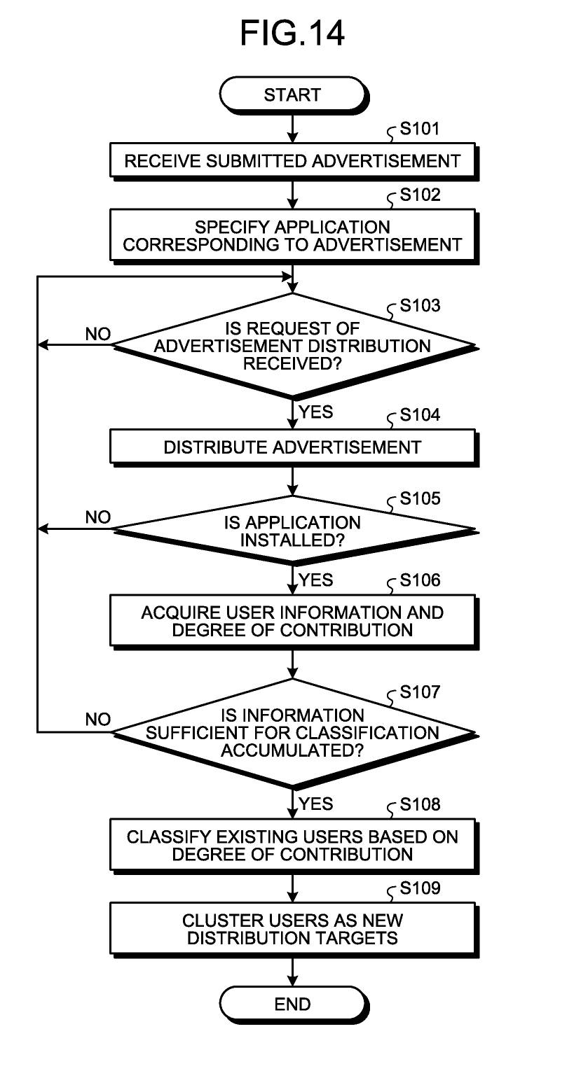

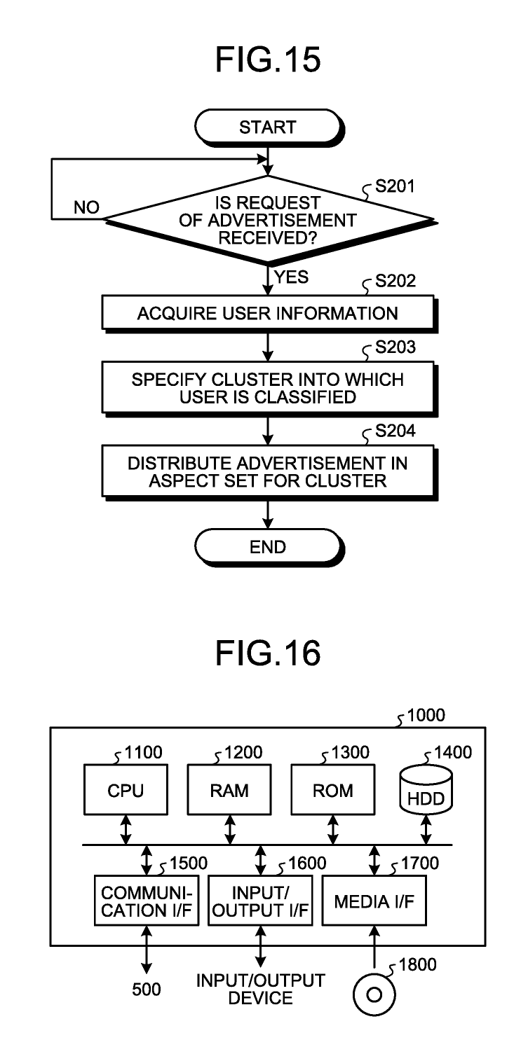

Next, the following describes a processing procedure performed by the determination device 100 according to the embodiment with reference to FIGS. 14 and 15. First, the following describes processing of classifying existing users and a processing procedure related to clustering with reference to FIG. 14. FIG. 14 is a flowchart (1) illustrating a processing procedure according to the embodiment.

As illustrated in FIG. 14, the determination device 100 receives the advertisement submitted from the advertiser terminal 20 (Step S101). The determination device 100 then specifies an application corresponding to the submitted advertisement (Step S102).

Thereafter, the determination device 100 determines whether a request of advertisement distribution is received from the user terminal 10 (Step S103). If the request of advertisement distribution is not received, the determination device 100 waits until receiving the request (No at Step S103).

On the other hand, if the request of advertisement distribution is received (Yes at Step S103), the determination device 100 distributes the advertisement to the user terminal 10 that has transmitted the request (Step S104). Thereafter, the determination device 100 determines whether the application related to the advertisement is installed in the user terminal 10 (Step S105).

If the application related to the advertisement is not installed (No at Step S105), information about the degree of contribution cannot be acquired from the user terminal 10 in which the application is not installed, so that the determination device 100 repeatedly performs processing of receiving the request of advertisement distribution. On the other hand, if the application related to the advertisement is installed (Yes at Step S105), the determination device 100 acquires the user information related to the user terminal 10 in which the application is installed and the degree of contribution related to the application (Step S106).

The determination device 100 determines whether information sufficient for classifying the user who has installed the application is accumulated (Step S107). As a sufficient amount of information required for classification, for example, the determination device 100 is assumed to previously receive a setting of a predetermined number of samples (for example, 100000) to be accumulated from an administrator and the like of the determination device 100. If a sufficient amount of information required for classification is not accumulated (No at Step S107), the determination device 100 repeatedly performs processing of receiving the request of advertisement distribution from another user terminal 10.

On the other hand, if a sufficient amount of information required for classification is accumulated (Yes at Step S107), the determination device 100 classifies the existing users based on the degree of contribution (Step S108). The determination device 100 clusters users as new distribution targets based on the classification of the existing users (Step S109).

Next, the following describes a processing procedure related to advertisement distribution with reference to FIG. 15. FIG. 15 is a flowchart (2) illustrating a processing procedure according to the embodiment.

As illustrated in FIG. 15, the determination device 100 determines whether the request of advertisement distribution is received from the user terminal 10 (Step S201). If the request of advertisement distribution is not received, the determination device 100 waits until receiving the request (No at Step S201).

On the other hand, if the request of advertisement distribution is received (Yes at Step S201), the determination device 100 acquires the user information from the user terminal 10 that has transmitted the request (Step S202). The determination device 100 specifies the cluster to which the user terminal 10 that has transmitted the request of advertisement distribution belongs based on the acquired user information (Step S203). The determination device 100 then distributes the advertisement in an aspect set for the cluster (Step S204).

6. Modification

The determination device 100 may be implemented in various different forms other than the embodiment described above. The following describes other embodiments of the determination device 100.

6-1. Type of Application

In the embodiment described above, the application A10 as a processing target is a game application by way of example. However, the determination device 100 may perform the determination processing described above on an application or a service other than the game application.

For example, the determination device 100 may cause a shopping application, a news application, or the like to be a processing target. For example, when the shopping application is a processing target, for example, the determination device 100 performs the determination processing described above using a purchase amount of the user for a commodity purchased via the application as the degree of contribution. When the news application is a processing target, for example, the determination device 100 may perform the determination processing described above using, as the degree of contribution, the number of times when the user starts the application within 24 hours, total time during which the user views the application, the number of advertisements displayed in the application, and the like.

6-2. Degree of Contribution

In the above embodiment, an amount of charge and the like on the application A10 as a processing target is the degree of contribution by way of example. The determination device 100 may measure the degree of contribution of the user based on a relation between the application A10 and another application installed in the user terminal 10.

For example, there may be applications competing with each other in similar genres. For example, regarding the game application such as the application A10 or an application for providing information such as news, an application similar thereto may be provided by a plurality of application providers.

For example, the determination device 100 acquires not only a use history related to the application A10 but also a use history related to a competing application (in this case, it is assumed to be an “application A11”). The determination device 100 acquires, for example, transition related to the use history of the application A11 after the application A10 is installed. For example, the determination device 100 acquires not only the number of times when the application A10 is started but also the number of times when the application A11 is started within a predetermined period. The determination device 100 then acquires the fact that the number of times when the application A11 is started is reduced after the application A10 is installed.

In this case, it can be considered that the user has switched a frequently used application from the application A11 to the similar application A10. In this point, it can be said that the user increases share of the application A10 in a market configured of applications similar to the application A10. In other words, the user can be said to have a high degree of contribution to the application A10 from a viewpoint that the user switches the application to be used from the application A11 to the application A10 although the user has not paid a charge for the application A10.

In this way, the determination device 100 also acquires the use history of the application similar to the application as a processing target. The determination device 100 may estimate the degree of contribution of the user based on a tendency of the use history of the application similar to the application as a processing target in the user terminal 10. That is, the determination device 100 may measure the degree of contribution of the user based on not only the use history of the application itself but also the use history of a competing application. Accordingly, the determination device 100 can determine an aspect of advertisement distribution using the degree of contribution of the user in accordance with actual circumstances.

6-3. Use of Degree of Contribution

The determination device 100 may measure the degree of contribution of the user from a different viewpoint based on the use history of the user of a competing application.

For example, it is assumed that applications A21 and A22 related to shopping are present as competing applications. A user U21 is assumed to be a user who frequently purchases a commodity using the application A21. It is assumed that the user U21 has not installed the application A22.

In this case, when the user U21 installs the application A22, the determination device 100 may perform processing of estimating the degree of contribution of the user U21 to the application A22 to be higher as compared to those of other users. That is, the determination device 100 may determine that the user U21 who frequently uses the application A21 related to shopping is a user having a high possibility of frequently using the similar application A22. In other words, it can be said that the user U21 is a user who does shopping via the application without hesitation, and who has a high possibility of growing up to be a user who frequently uses not only the application A21 but also the application A22. In this way, by acquiring the use history of the application competing with (similar to) the application as a processing target, the determination device 100 can grasp the degree of contribution of the user from many different angles. As a result, the determination device 100 can determine a distribution aspect of distributing the advertisement accurately focusing on a user having a high degree of contribution.

6-4. Type of Information Content

In the embodiment described above, the information content is the advertisement for prompting installation of the application. However, the information content is not limited to the advertisement, and may be recommendation information of the application, for example.

6-5. Type of User Information

In the embodiment described above, the acquisition unit 133 acquires, as the user information, the attribute information of the user of the user terminal 10, the device information of the user terminal 10, and the application information. In the embodiment described above, the estimation unit 136 estimates the degree of contribution to the application based on the information acquired by the acquisition unit 133. The acquisition unit 133 is not limited thereto, and may acquire further different pieces of user information.

For example, the acquisition unit 133 may acquire a type or version information of an operating system (OS) of the user terminal 10, resolution of a vertical screen and a horizontal screen, a total number of pixels, and the like.

The acquisition unit 133 may use the behavior history of the user on the network as the user information. For example, the acquisition unit 133 may acquire, from the user terminal 10, a type of the Web page to be viewed, a Web search history, and the like.

6-6. Relation to Medium

In the embodiment described above, the determination device 100 distributes the advertisement to the user terminal 10 based on the aspect determined by the determination unit 137. The determination unit 137 may also distribute the advertisement based on a predetermined condition received from the advertiser.

For example, some advertisers designate medium content (for example, a Web page and an application) in which the advertisement submitted by himself/herself is displayed. Specifically, to increase a customer appeal of the advertisement, the advertiser desires to display the advertisement of himself/herself in content including information of a specific category in some cases. Alternatively, the advertiser desires not to display the advertisement submitted by himself/herself in a Web page provided by a rival company in some cases.

In this case, the determination unit 137 may determine the aspect of distributing the advertisement taking into account a condition designated by the advertiser. Due to this, the advertiser can cause the advertisement not to be displayed in the Web page not desired by the advertiser to insert the advertisement of himself/herself although the Web page is to be displayed by the user having a high possibility of installing the application.

6-7. Medium

In the embodiment described above, as a medium in which information content such as an advertisement is inserted, a Web page provided by the Web server 30 is exemplified. However, information content provided by the determination device 100 may be displayed in a predetermined space, not limited to the Web page. For example, the determination device 100 may distribute the advertisement to an advertisement display space provided in the application.

7. Hardware Configuration

The determination device 100 and the user terminal 10 according to the embodiment described above are implemented by a computer 1000 having a configuration as illustrated in FIG. 16, for example. The following describes the determination device 100 by way of example. FIG. 16 is a hardware configuration diagram illustrating an example of the computer 1000 that implements a function of the determination device 100. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates based on a computer program stored in the ROM 1300 or the HDD 1400, and controls each component. The ROM 1300 stores therein a boot program executed by the CPU 1100 at the time when the computer 1000 is activated, a computer program depending on hardware of the computer 1000, and the like.

The HDD 1400 stores therein a computer program executed by the CPU 1100, data used by the program, and the like. The communication interface 1500 receives data from another appliance via a communication network 500 (corresponding to the network N illustrated in FIG. 3) to be transmitted to the CPU 1100, and transmits data generated by the CPU 1100 to another appliance via the communication network 500.

The CPU 1100 controls an output device such as a display and a printer, and an input device such as a keyboard and a mouse via the input/output interface 1600. The CPU 1100 acquires data from the input device via the input/output interface 1600. The CPU 1100 outputs the generated data to the output device via the input/output interface 1600.

The media interface 1700 reads a computer program or data stored in a recording medium 1800, and provides the program or data to the CPU 1100 via the RAM 1200. The CPU 1100 loads the program from the recording medium 1800 into the RAM 1200 via the media interface 1700, and executes the loaded program. Examples of the recording medium 1800 include an optical recording medium such as a digital versatile disc (DVD) and a phase change rewritable disk (PD), a magneto-optical recording medium such as a magneto-optical disk (MO), a tape medium, a magnetic recording medium, or a semiconductor memory.

For example, when the computer 1000 functions as the determination device 100 according to the embodiment, the CPU 1100 of the computer 1000 executes the program loaded into the RAM 1200 to implement the function of the control unit 130. The HDD 1400 stores therein data within the storage unit 120. The CPU 1100 of the computer 1000 reads these programs from the recording medium 1800 to be executed. Alternatively, the CPU 1100 of the computer 1000 may acquire these programs from another device via the communication network 500.

8. Others

Among the pieces of processing described in the above embodiment, all or part of the pieces of processing described to be automatically performed can be manually performed, or all or part of the pieces of processing described to be manually performed can be automatically performed using a known method. A processing procedure, a specific name, information including various pieces of data and parameters that are described above and illustrated in the drawings can be optionally changed unless otherwise specifically noted. For example, the various pieces of information illustrated in the drawings are not limited thereto.

The components of the devices illustrated in the drawings are merely conceptual, and it is not necessarily required that they are physically configured as illustrated. That is, specific forms of distribution and integration of the devices are not limited to those illustrated in the drawings. All or part thereof may be functionally or physically distributed/integrated in arbitrary units depending on various loads or usage states. For example, the reception unit 132 and the acquisition unit 133 illustrated in FIG. 4 may be integrated with each other. For example, information stored in the storage unit 120 may be stored in a predetermined external storage device via the network N.

In the embodiment described above, for example, the determination device 100 performs reception processing of receiving the submitted advertisement (information content), determination processing of determining the aspect of advertisement distribution for each cluster, and distribution processing of distributing the advertisement. However, the determination device 100 described above may be separated into a reception device that performs reception processing, a determination device that performs determination processing, and a distribution device that performs distribution processing. In this case, the reception device includes at least the submission reception unit 131. The determination device includes at least the determination unit 137. The distribution device includes at least the distribution unit 138. The pieces of processing performed by the determination device 100 described above are implemented by the determination processing system 1 including the respective devices, that is, the reception device, the determination device, and the distribution device.

The embodiments and modifications described above can be appropriately combined without contradiction in processing content.

9. Effects

As described above, the determination device 100 according to the embodiment includes the acquisition unit 133, the estimation unit 136, and the determination unit 137. The acquisition unit 133 acquires the user information as information about the user. The estimation unit 136 estimates the degree of contribution of the user to a predetermined service based on the user information acquired by the acquisition unit 133. The determination unit 137 determines the aspect of providing information content to the user based on the degree of contribution estimated by the estimation unit 136.

In this way, the determination device 100 according to the embodiment can estimate the degree of contribution to the predetermined service of the user as a provision target of the information content, and determine the aspect of providing the information content based on the estimated information. That is, by estimating the degree of contribution to the service related to the information content, the determination device 100 can determine the provision aspect of the information content taking into account a reward obtained from the user when the information content produces a favorable result (for example, when the predetermined service acquires the user). Accordingly, the determination device 100 can appropriately adjust cost taken for providing the information content in accordance with the result produced by the information content, so that cost effectiveness of the information content can be improved.

The estimation unit 136 estimates the degree of contribution of the user as a new provision destination of the information content based on a relation between the user information acquired by the acquisition unit 133 and the use history of a predetermined service in the user group that used the predetermined service in the past.

In this way, the determination device 100 according to the embodiment estimates the degree of contribution based on the use history of the user who has already used the predetermined service. That is, the determination device 100 estimates the degree of contribution of the user as a new provision target based on a track record of the user who has used the service, so that the degree of contribution can be accurately estimated.

The determination unit 137 determines the aspect of providing the information content for each cluster into which the user as a new provision destination of the information content is classified based on a relation between the user information and the degree of contribution estimated by the estimation unit 136.

In this way, the determination device 100 according to the embodiment clusters the user as a provision target based on the user information, and determines the provision aspect for each cluster. For example, by organizing users through hierarchical clustering, the determination device 100 can enhance similarity to the existing user. Accordingly, the determination device 100 can accurately determine the provision aspect of the information content such as providing, with high cost, the information content to the user belonging to the cluster corresponding to the existing user having a high degree of contribution.

The acquisition unit 133 acquires, as the user information, at least one of the distinction of sex, the age, the place of residence, and the commuting time of the user. The determination unit 137 determines the aspect of providing the information content for each cluster that is classified based on a relation between at least one of the distinction of sex, the age, the place of residence, and the commuting time of the user and the degree of contribution estimated by the estimation unit 136.

In this way, the determination device 100 according to the embodiment performs processing using the attribute information and the like of the user. Accordingly, the determination device 100 can accurately grasp the user similar to the existing user, so that the information content can be provided with high effectiveness.

As the aspect of providing the information content, the determination unit 137 determines at least one of cost taken for providing the information content to a predetermined user, frequency of providing the information content, and content of the information content to be provided.

In this way, the determination device 100 according to the embodiment can determine various elements as provision aspects. Thus, the determination device 100 can perform flexible provision processing adapted to the user such as providing many types of information content for acquiring the user having a high degree of contribution, and frequently providing the information content, for example.

The determination unit 137 determines the aspect of providing the information content so that, as the degree of contribution of the user estimated by the estimation unit 136 is higher, at least one of the cost taken for providing the information content, the frequency of providing the information content, and frequency of change in the content of the information content to be provided becomes higher.

In this way, the determination device 100 according to the embodiment increases the cost taken for providing the information content depending on the degree of contribution. That is, the determination device 100 can appropriately adjust the focus of the information content such that high cost is taken for acquiring the user having a high degree of contribution. Accordingly, the determination device 100 can improve cost effectiveness in providing the information content.

The estimation unit 136 estimates the degree of contribution of the user to a predetermined service based on at least one of a behavior of the user for the predetermined service, frequency of using the predetermined service by the user, and time during which the user uses the predetermined service.

In this way, the determination device 100 according to the embodiment estimates the degree of contribution of the user based on the behavior of the user for the predetermined service such as paying a charge for the service by the user. That is, the determination device 100 estimates the degree of contribution of the user considering a specific reward given by the user in the predetermined service, so that a return in a case of acquiring the user due to the information content can be easily estimated. Thus, the cost taken for providing the information content can be adjusted more accurately.

The acquisition unit 133 acquires, as the user information, information about the user terminal 10 that is used by the user and in which the application for using the predetermined service can be installed. The estimation unit 136 estimates the degree of contribution of the user to the application in a case in which the application is installed in the user terminal 10. The determination unit 137 determines the aspect of providing, to the user, the information content for prompting the user to install the application in the user terminal 10 based on the degree of contribution estimated by the estimation unit 136.

In this way, the determination device 100 according to the embodiment determines the provision aspect in providing the information content to the user terminal 10 in which the application is installed based on the degree of contribution in a case in which the application is installed. That is, the determination device 100 can adjust the cost and the like taken until the user installs the application depending on the estimated degree of contribution, so that cost effectiveness of the information content can be improved.

The acquisition unit 133 acquires, as information about the user terminal 10, at least one of the model number, the brand name, the time elapsed from its release, the name of communication carrier, the manufacturer name, and the resolution set for the user terminal 10. The estimation unit 136 estimates the degree of contribution of the user as a new provision destination of the information content based on a relation between the information about the user terminal 10 acquired by the acquisition unit 133 and the use history of the application in the user group that used the application in the past.

In this way, the determination device 100 according to the embodiment estimates the degree of contribution of the user to the application based on the information included in the device of the user terminal 10. Typically, in the user terminal 10 such as a smartphone, there is a predetermined correlation with use frequency of the application to be used such as an attribute of the user who prefers the terminal and a screen size. For example, by using, for processing, characteristic information and the like of a terminal used by a user who tends to frequently pay a charge, the determination device 100 can estimate the degree of contribution to the application more accurately.

The acquisition unit 133 acquires, as information about the user terminal 10, at least one of the pieces of information including a total number of applications installed in the user terminal 10, the number of game applications installed in the user terminal 10, a proportion of the number of game applications to the total number of applications installed in the user terminal 10, and a genre of each game application installed in the user terminal 10. The estimation unit 136 estimates the degree of contribution of the user as a new provision destination of the information content based on a relation between the information about the user terminal 10 acquired by the acquisition unit 133 and the use history of the application in the user group that used the application in the past.

In this way, the determination device 100 according to the embodiment may estimate the degree of contribution of the user taking into account the information of the application installed in the user terminal 10. Accordingly, for example, the determination device 100 can accurately estimate the degree of contribution of the user having application information similar to the application information of the existing user based on the information about the existing user.

The embodiment of the present application has been described above in detail based on the drawings, but this is merely an example. The present invention can be implemented in other forms that are variously modified or improved based on knowledge of those skilled in the art in addition to the aspects described herein.

The word such as “section, module, and unit” described above can also be read as “means”, a “circuit”, and the like. For example, the acquisition unit can also be read as acquisition means or an acquisition circuit.

According to an aspect of the embodiment, the cost effectiveness of the information content can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A determination device comprising:
an acquisition unit that acquires user information as information about a user;
an estimation unit that estimates a degree of contribution of the user to a predetermined service based on the user information acquired by the acquisition unit; and
a determination unit that determines an aspect of providing information content to the user based on the degree of contribution estimated by the estimation unit.

2. The determination device according to claim 1, wherein
the estimation unit estimates the degree of contribution of a user as a new provision destination of the information content based on a relation between the user information acquired by the acquisition unit and a use history of the predetermined service in a user group that used the predetermined service in the past.

3. The determination device according to claim 2, wherein
the determination unit determines an aspect of providing the information content for each cluster into which a user as a new provision destination of the information content is classified based on a relation between the user information and the degree of contribution estimated by the estimation unit.

4. The determination device according to claim 3, wherein
the acquisition unit acquires at least one of a distinction of sex, age, a place of residence, and commuting time of the user as the user information, and
the determination unit determines an aspect of providing the information content for each cluster that is classified based on a relation between at least one of the distinction of sex, the age, the place of residence, and the commuting time of the user and the degree of contribution estimated by the estimation unit.

5. The determination device according to claim 1, wherein
the determination unit determines, as an aspect of providing the information content, at least one of cost taken for providing the information content to a predetermined user, frequency of providing the information content, and content of the information content to be provided.

6. The determination device according to claim 5, wherein
the determination unit determines an aspect of providing information content so that, as the degree of contribution of the user estimated by the estimation unit is higher, at least one of the cost taken for providing the information content, the frequency of providing the information content, and frequency of change in the content of the information content to be provided becomes higher.

7. The determination device according to claim 1, wherein
the estimation unit estimates the degree of contribution of the user to the predetermined service based on at least one of a behavior of the user for the predetermined service, frequency of using the predetermined service by the user, and time during which the user uses the predetermined service.

8. The determination device according to claim 1, wherein
the acquisition unit acquires, as user information, information about a terminal device that is used by the user and in which an application for using a predetermined service is able to be installed;
the estimation unit estimates the degree of contribution of the user to the application in a case in which the application is installed in the terminal device; and
the determination unit determines an aspect of providing, to the user, information content for prompting the user to install the application in the terminal device based on the degree of contribution estimated by the estimation unit.

9. The determination device according to claim 8, wherein
the acquisition unit acquires, as information about the terminal device, at least one of a model number, a brand name, a time elapsed from its release, a name of communication carrier, a manufacturer name, and resolution set for the terminal device, and
the estimation unit estimates the degree of contribution of a user as a new provision destination of the information content based on a relation between the information about the terminal device acquired by the acquisition unit and a use history of the application in a user group that used the application in the past.

10. The determination device according to claim 8, wherein
the acquisition unit acquires, as the information about the terminal device, at least one of pieces of information including a total number of applications installed in the terminal device, the number of game applications installed in the terminal device, a proportion of the number of game applications to the total number of applications installed in the terminal device, and a genre of each game application installed in the terminal device, and
the estimation unit estimates the degree of contribution of a user as a new provision destination of the information content based on a relation between the information about the terminal device acquired by the acquisition unit and a use history of the application in a user group that used the application in the past.

11. A determination method executed by a computer, the method comprising:
acquiring user information as information about a user;
estimating a degree of contribution of the user to a predetermined service based on the user information acquired at the acquiring; and
determining an aspect of providing information content to the user based on the degree of contribution estimated at the estimating.

12. A non-transitory computer readable recording medium having stored therein a determination program that causes a computer to execute a process comprising:
acquiring user information as information about a user;
estimating a degree of contribution of the user to a predetermined service based on the user information acquired in the acquisition procedure; and
determining an aspect of providing information content to the user based on the degree of contribution estimated in the estimation procedure.
